(19) United States
(12) Patent Application Publication
(10) Pub. No.: US 2026/0222500 A1
(43) Pub. Date: Jul. 30, 2026

(54) PRINTING APPARATUS AND CONTROL METHOD

(71) Applicant: SEIKO EPSON CORPORATION, Tokyo (JP)

(72) Inventor: Kensaku NITTA, Matsumoto (JP)

(21) Appl. No.: 19/460,424

(22) Filed: Jan. 27, 2026

(30) Foreign Application Priority Data
Jan. 29, 2025 (JP) 2025-012817

(51) Int. Cl. H04N 1/00; B41J 3/46; H04N 1/44

(52) U.S. Cl. CPC H04N 1/00427; B41J 3/46; H04N 1/00424; H04N 1/00482; H04N 1/0097; H04N 1/4413; H04N 1/4426

(57) ABSTRACT

A printing apparatus includes a printing section that performs printing, an operation panel that displays a plurality of operation keys and that receives an operation performed by a user, a controller that controls the operation panel, and a communication section that communicates with an external device. The plurality of operation keys include a user setting key for which the operation performed on the operation panel by the user is registered, and when the user performs the operation on the operation panel, the controller performs a storage process of storing operation information based on the operation and a registration process of registering the operation information for the user setting key.

The present application is based on, and claims priority from JP Application Serial Number 2025-012817, filed January 29, 2025, the disclosure of which is hereby incorporated by reference herein in its entirety.

### BACKGROUND

### 1. Technical Field

The present disclosure relates to a printing apparatus and a control method.

### 2. Related Art

A recording apparatus provided with an operation panel is known. A printer described in JP-A-2021-59394 includes an operation panel that displays various icons. The printer is an example of a recording apparatus. The operation panel includes a first display portion and a second display portion. The first display portion displays menu icons of various processes such as a copying process and a scanning process. The second display portion displays icons at fixed predetermined positions. The user can access an icon other than the menu icons of various processes by scrolling the operation panel in a longitudinal direction.

A user needs to perform a scrolling operation and to search for a desired icon to access the desired icon, and there is room for improvement in terms of workability.

### SUMMARY

According to an aspect of the present disclosure, there is provided a printing apparatus including a printing section that performs printing, an operation panel that displays a plurality of operation keys and that receives an operation performed by a user, a controller that controls the operation panel, and a communication section that communicates with an external device. The plurality of operation keys include a user setting key for which the operation performed on the operation panel by the user is registered, and when the user performs the operation on the operation panel, the controller performs a storage process of storing operation information based on the operation and a registration process of registering the operation information for the user setting key.

According to another aspect of the present disclosure, there is provided a control method for a printing apparatus including a printing section that performs printing and an operation panel that displays a plurality of operation keys including a user setting key and that receives an operation performed by a user, the method including receiving the operation that is performed on the operation panel by the user, storing operation information based on the operation, and registering the operation information for the user setting key.

### BRIEF DESCRIPTION OF THE DRAWINGS

FIG. 1 is a view showing a schematic configuration of a printer.

FIG. 2 is a diagram showing a block configuration of a printing system including the printer.

FIG. 3 is a view showing a schematic configuration of a control panel.

FIG. 4 is a flowchart showing an example of control flow executed by the printer.

FIG. 5 is a view showing a schematic configuration of the control panel.

FIG. 6 is a view showing a schematic configuration of the control panel.

FIG. 7 is a view showing a schematic configuration of the control panel.

FIG. 8 is a view showing a schematic configuration of the control panel.

FIG. 9 is a view showing a schematic configuration of the control panel.

FIG. 10 is a view showing a schematic configuration of the control panel.

FIG. 11 is a view showing a schematic configuration of the control panel.

FIG. 12 is a flowchart showing an example of control flow executed by the printer.

FIG. 13 is a flowchart showing an example of control flow executed by the printer.

FIG. 14 is a view showing a schematic configuration of the control panel.

FIG. 15 is a flowchart showing an example of control flow executed by the printer.

FIG. 16 is a view showing a schematic configuration of the control panel.

FIG. 17 is a view showing a schematic configuration of the control panel.

FIG. 18 is a view showing a schematic configuration of the control panel.

FIG. 19 is a view showing a schematic configuration of the control panel.

FIG. 20 is a view showing a schematic configuration of the control panel.

FIG. 21 is a view showing a schematic configuration of the control panel.

FIG. 22 is a view showing a schematic configuration of the control panel.

FIG. 23 is a view showing a schematic configuration of the control panel.

FIG. 24 is a view showing a schematic configuration of the control panel.

### DESCRIPTION OF EMBODIMENTS

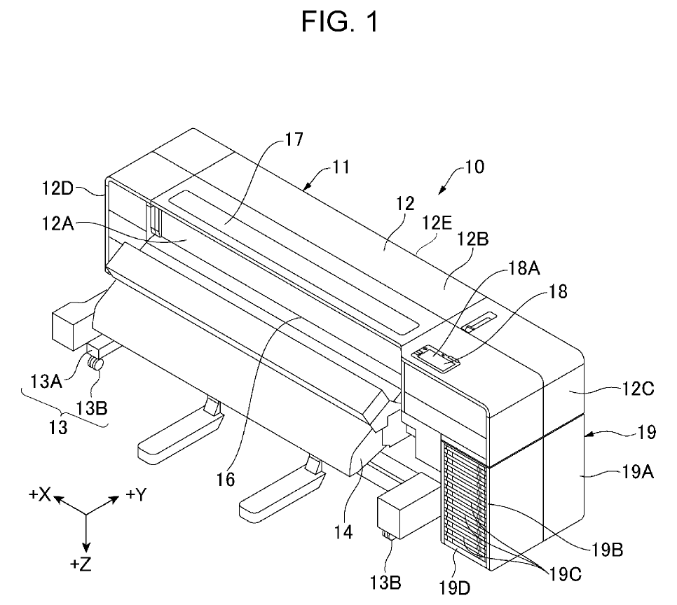

FIG. 1 shows a schematic configuration of a printer 10. FIG. 1 is a perspective view showing the printer 10. The printer 10 is a serial scan type ink jet printer. The printer 10 is, for example, a large format printer that performs printing on an A1-size medium or a larger medium. The printer 10 acquires a printing job from an external printing control device 70. The printer 10 prints an image on a medium by ejecting ink to the medium in accordance with printing data based on the printing job. The printer 10 corresponds to an example of a printing apparatus.

FIG. 1 shows an XYZ coordinate system. A Z axis is an axis perpendicular to an installation surface of the printer 10. A -Z direction is a direction from the installation surface to an upper side. A +Z direction is a direction from the upper side to the installation surface. A Y axis is an axis perpendicular to the Z axis. The Y axis is an axis parallel to a direction in which accommodation trays 19C, which will be described later, are mounted. A +Y direction is a direction from a front surface 12A of a housing 12, which will be described later, to a rear surface 12E of the housing 12. A -Y direction is a direction from the rear surface 12E of the housing 12 to the front surface 12A. An X axis is an axis perpendicular to the Y axis and the Z axis. A -X direction is a direction from the left to the right in a plan view as seen from a position facing the front surface 12A. A +X direction is a direction from the right to the left in the plan view as seen from the position facing the front surface 12A.

The printer 10 includes an apparatus main body 11 and a liquid supply device 19. The apparatus main body 11 accommodates a printing mechanism 20 which will be described later. The liquid supply device 19 accommodates one or a plurality of inks. The ink accommodated in the liquid supply device 19 is supplied to the printing mechanism 20. The apparatus main body 11 includes the housing 12, support stands 13, a supply section 14, a window portion 17, and a control panel 18.

The housing 12 is an exterior of the apparatus main body 11. The housing 12 is formed to have an approximately rectangular parallelepiped-like shape of which the width along the X axis is larger than the depth along the Y axis, for example. The housing 12 includes the front surface 12A, a top surface 12B, a first side surface 12C, a second side surface 12D, and the rear surface 12E. The front surface 12A is a surface of the housing 12 that faces the -Y direction. The top surface 12B is a surface of the housing 12 that faces the -Z direction. The first side surface 12C is a surface of the housing 12 that faces the -X direction. The second side surface 12D is a surface of the housing 12 that faces the +X direction. The rear surface 12E is a surface of the housing 12 that faces the +Y direction.

The support stands 13 support the housing 12. The printer 10 shown in FIG. 1 includes two support stands 13. The two support stands 13 are provided at a position in the +X direction and a position in the -X direction with respect to the housing 12, respectively. The number of support stands 13 is not limited to two. The number of support stands 13 is appropriately set. The support stands 13 include leg portions 13A and casters 13B.

The leg portions 13A are provided at positions in the +Z direction with respect to the support stands 13. The leg portions 13A are members extending along the Y axis.

The casters 13B support the printer 10 to be movable. The casters 13B are provided at positions in the +Z direction with respect to the leg portions 13A. The printer 10 shown in FIG. 1 is provided with the casters 13B. However, the present disclosure is not limited thereto. The printer 10 may not include the casters 13B.

The supply section 14 supports a roll body (not shown). Around the roll body, a medium such as long paper, cloth, or the like is wound cylindrically. The supply section 14 supports the roll body to be rotatable. The supply section 14 is provided at a position in the-Y direction with respect to the printer 10. The supply section 14 supplies, to the printing mechanism 20 accommodated in the housing 12, a medium wound around the roll body.

A medium transported in the housing 12 is discharged through a discharge port 16. A medium on which printing is performed by the printing mechanism 20 is discharged through the discharge port 16. The discharge port 16 is provided at the front surface 12A of the housing 12. A medium receiving unit (not shown) accommodates the medium discharged through the discharge port 16, for example. The medium discharged through the discharge port 16 may be wound around a winding roll body (not shown).

The window portion 17 is configured such that the inside of the housing 12 can be visually recognized through the window portion 17. The window portion 17 is configured by using a light-transmitting member. A user can check a medium transported in the housing 12 via the window portion 17. The window portion 17 is provided at the top surface 12B. The window portion 17 is configured in a rectangular shape of which the width along the X axis is larger than the length along the Y axis.

The control panel 18 receives various inputting operations performed by a user. The control panel 18 corresponds to an example of an operation panel. The control panel 18 is provided at the top surface 12B. The control panel 18 has an input function of receiving various inputting operations and a displaying function of displaying various screens and the like. The control panel 18 includes a display panel 18A. The control panel 18 may include a plurality of input buttons.

The display panel 18A displays various screens and the like. The various screens to be displayed on the display panel 18A will be described later. The display panel 18A is configured by using a display having a touch input function, for example. The display is configured by using a liquid crystal panel, an organic electroluminescence (EL) panel, or the like.

The liquid supply device 19 is configured to be couplable to the apparatus main body 11. The liquid supply device 19 includes a supply unit main body 19A, a supply unit housing 19B, the accommodation trays 19C, and a waste liquid accommodation portion 19D.

The supply unit main body 19A accommodates the accommodation trays 19C, the waste liquid accommodation portion 19D, and the like. The supply unit main body 19A is disposed at a position in the -X direction with respect to the apparatus main body 11. The supply unit main body 19A is supported by a notch portion (not shown) provided at the apparatus main body 11.

The supply unit housing 19B is an exterior of the supply unit main body 19A. A plurality of insertion ports are provided in a surface in the -Y direction of the supply unit housing 19B.

The accommodation trays 19C are mounted into the insertion ports of the supply unit housing 19B. The accommodation trays 19C are configured to be attachable and detachable along the Y axis with respect to the insertion ports of the supply unit housing 19B. A plurality of the accommodation trays 19C are mounted to the supply unit housing 19B. The plurality of accommodation trays 19C are mounted into the plurality of insertion ports, respectively. The accommodation trays 19C accommodate liquid supply sources. The liquid supply sources are, for example, ink packs that accommodate ink. The liquid supply sources may be ink cartridges, ink tanks, or the like. The plurality of accommodation trays 19C accommodate inks having different colors, respectively.

The waste liquid accommodation portion 19D accommodates ink leaking in the supply unit housing 19B as waste liquid. The waste liquid accommodation portion 19D is disposed at a position in the +Z direction with respect to the supply unit main body 19A. The waste liquid accommodation portion 19D is, for example, a waste liquid tray configured to be attachable and detachable with respect to the supply unit housing 19B.

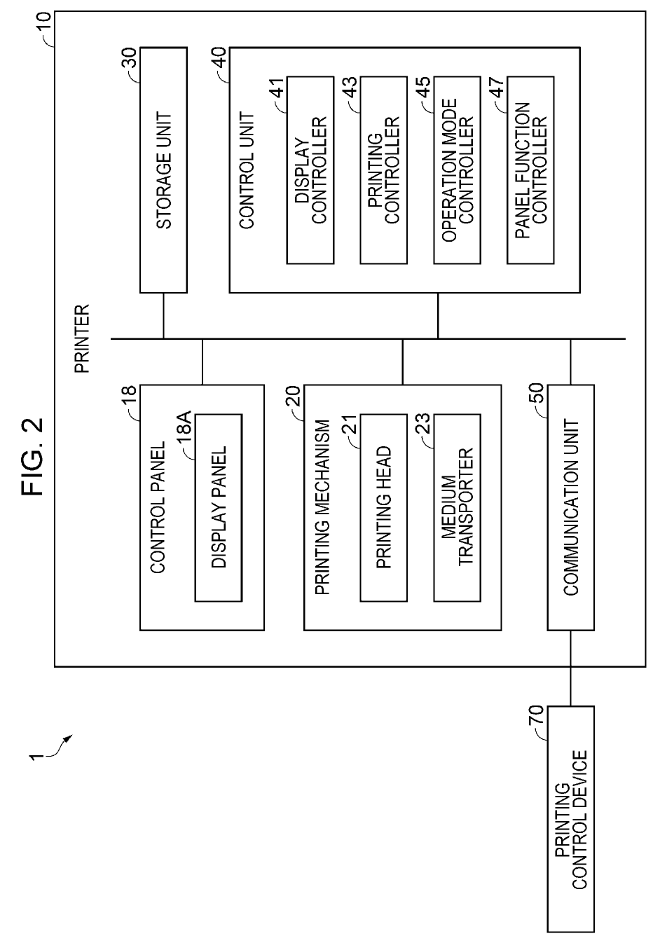

FIG. 2 shows a block configuration of a printing system 1 including the printer 10. The printing system 1 includes the printer 10 and the printing control device 70. FIG. 2 shows the printing system 1 in which the printer 10 and the printing control device 70 are separate from each other. However, the present disclosure is not limited thereto. The printer 10 and the printing control device 70 may be configured to be integrated with each other. FIG. 2 shows the printing system 1 including one printing control device 70. The printing system 1 may include a plurality of the printing control devices 70.

The printer 10 includes the control panel 18, the printing mechanism 20, a storage unit 30, a control unit 40, and a communication unit 50. In FIG. 2, the liquid supply device 19 and the like are not shown.

The control panel 18 generates input information based on various inputting operations performed by a user. The control panel 18 transmits the input information to the control unit 40. The control panel 18 receives screen data or the like from the control unit 40. The control panel 18 causes the display panel 18A to display the screen data or the like. The control panel 18 causes various display screens to be displayed by means of the display panel 18A. The control panel 18 receives various setting data from the control unit 40. The control panel 18 sets the functions of various icons 120 to be displayed on the display panel 18A based on setting information that is set in advance. The various icons 120 are displayed in various screens such as a home screen 100.

The display panel 18A acquires the screen data or the like. The display panel 18A displays, based on the screen data or the like, various display screens such as the home screen 100 (which will be described later) and a setting screen. The display panel 18A displays one or more icons 120 in the various display screens. The icon 120 corresponds to an example of an operation key.

The printing mechanism 20 performs printing on a medium. The printing mechanism 20 corresponds to an example of a printing section. The printing mechanism 20 includes a printing head 21 and a medium transporter 23. The printing mechanism 20 includes a roll body rotation mechanism, a dryer, and the like (not shown). The roll body rotation mechanism is a mechanism that rotates the roll body supported by the supply section 14 and that feeds out a medium wound around the roll body. The dryer dries ink discharged to the medium.

The printing head 21 discharges ink to the medium. The printing head 21 prints an image or the like on the medium by discharging the ink on the medium. The printing head 21 discharges, onto the medium, one or more inks supplied from the liquid supply device 19.

The medium transporter 23 transports, to a position facing the printing head 21, the medium wound around the roll body supported by the supply section 14. The medium transporter 23 transports, toward the discharge port 16, the medium onto which the ink is discharged by the printing head 21. The medium transporter 23 includes a plurality of transportation roller pairs, a medium supporting member, and the like. The plurality of transportation roller pairs and the medium supporting member are not shown.

The storage unit 30 stores various information, programs, and the like. The storage unit 30 stores a program such as firmware for the controlling of the printer 10. The storage unit 30 stores screen data to be displayed on the display panel 18A. The storage unit 30 is composed of a semiconductor memory such as a read only memory (ROM) and a random access memory (RAM). The storage unit 30 may be composed of a magnetic recording medium such as a hard disk drive (HDD).

The control unit 40 is a printer controller that controls the printer 10. The control unit 40 corresponds to an example of a controller. The control unit 40 controls various units such as the control panel 18, the printing mechanism 20, and the communication unit 50. The control unit 40 is, for example, a processor including a central processing unit (CPU). The control unit 40 is composed of one or a plurality of processors. The control unit 40 functions as various functional units by executing firmware stored in the storage unit 30. The control unit 40 functions as a display controller 41, a printing controller 43, an operation mode controller 45, and a panel function controller 47. The control unit 40 may function as a functional section other than the display controller 41, the printing controller 43, the operation mode controller 45, and the panel function controller 47.

The display controller 41 controls the display panel 18A included in the control panel 18 to cause the display panel 18A to display various screens and the like. The display controller 41 generates various screen data and the like and transmits the various screen data to the control panel 18. The display controller 41 transmits screen data and the like to the control panel 18 to cause the display panel 18A to display various screen data and the like.

The printing controller 43 controls the printing mechanism 20 to cause the printing mechanism 20 to execute printing. The printing controller 43 generates printing data based on a printing job transmitted from the printing control device 70 or the like. The printing job includes a printing execution instruction that causes the printer 10 to execute printing. The printing job corresponds to an example of a printing instruction. The printing controller 43 transmits the printing data to the printing mechanism 20. The printing controller 43 transmits the printing data to the printing mechanism 20 to cause the printing mechanism 20 to execute printing. When the printing controller 43 receives the printing job transmitted from the printing control device 70 or the like, the printing controller 43 causes the printing mechanism 20 to transition into an idling state. The idling state is, for example, a state where the printing head 21 can discharge ink and the medium transporter 23 can transport a medium. The idling state corresponds to an example of a printing-ready state.

The operation mode controller 45 controls the operation mode of the printer 10. The operation mode controller 45 sets an operation mode based on an inputting operation performed by a user. The operation mode controller 45 causes the printing mechanism 20 and the like to operate in the set operation mode. Operation modes include a printing mode and an education mode. The operation modes may also include a mode other than the printing mode and the education mode.

The printing mode is a mode in which the printing mechanism 20 is caused to execute various setting operations or a printing operation based on an inputting operation performed on the control panel 18 by a user. When a user performs a predetermined inputting operation on the control panel 18, the operation mode controller 45 sets the printing mode as an operation mode. When the printing mode is set, the printing controller 43 receives printing settings set based on the inputting operation performed by the user. The printing controller 43 causes the printing mechanism 20 to operate by using the printing settings. The printing controller 43 may store the printing settings in the storage unit 30.

The education mode is a mode in which registration information stored in advance is displayed on the display panel 18A of the control panel 18. The education mode corresponds to an example of a displaying mode. The registration information is information that is registered in association with a user setting icon 122 which will be described later. The registration information corresponds to an example of operation information. When a user performs a predetermined inputting operation on the control panel 18, the operation mode controller 45 sets the education mode as an operation mode. When the education mode is set, the display controller 41 causes the display panel 18A to display an operation procedure. When the education mode is set, the printing controller 43 does not receive printing settings corresponding to an inputting operation performed on the control panel 18 and execution of printing in which the printing settings are used.

The panel function controller 47 performs a setting registration process of registering registration information for the user setting icon 122. The setting registration process corresponds to an example of a registration process. When a user performs an inputting operation, the panel function controller 47 performs a setting storage process of storing registration information based on the inputting operation. The setting storage process corresponds to an example of a storage process. The panel function controller 47 stores the registration information in the storage unit 30.

The registration information includes display registration information and execution registration information. The display registration information is information that causes the display panel 18A to display a display screen. When a user performs an inputting operation on the user setting icon 122 for which display registration information is registered, the display panel 18A displays a display screen included in the display registration information. The display screen receives an inputting operation performed by a user. The execution registration information is information that causes the printing mechanism 20 to operate. When the user performs an inputting operation on the user setting icon 122 for which execution registration information is registered, the printing mechanism 20 executes a predetermined operation. The predetermined operation is an adjustment operation, a maintenance operation, or the like. The execution registration information may include display registration information that causes the display panel 18A to display a predetermined display screen.

The communication unit 50 is an interface circuit that communicates with the printing control device 70 or the like. The communication unit 50 corresponds to an example of a communication section. The communication unit 50 is connected to the printing control device 70 or the like in a wired or wireless manner in accordance with a predetermined communication protocol. The communication unit 50 includes a wired connector, a wireless communication port, and the like. The wired connector is a universal serial bus (USB) connector, a local area network (LAN) connector, or the like. The wireless communication port is a wireless LAN port, a Bluetooth communication port, or the like. Bluetooth is a registered trademark. The communication unit 50 receives a printing job from the printing control device 70. The communication unit 50 transmits, to the printing control device 70, the result of printing based on the printing job.

The printing control device 70 causes the printer 10 to execute printing. The printing control device 70 corresponds to an example of an external device. The printing control device 70 transmits a printing job to the printer 10 to cause the printer 10 to execute printing. The printing control device 70 may generate registration information to be registered for the user setting icon 122 and transmit the registration information to the communication unit 50. A user causes the printing control device 70 to execute a printer controlling program and to generate the registration information. The printing control device 70 transmits the generated registration information to the communication unit 50. The communication unit 50 receives the registration information and transmits the registration information to the panel function controller 47. The panel function controller 47 acquires the registration information and registers the registration information for the user setting icon 122.

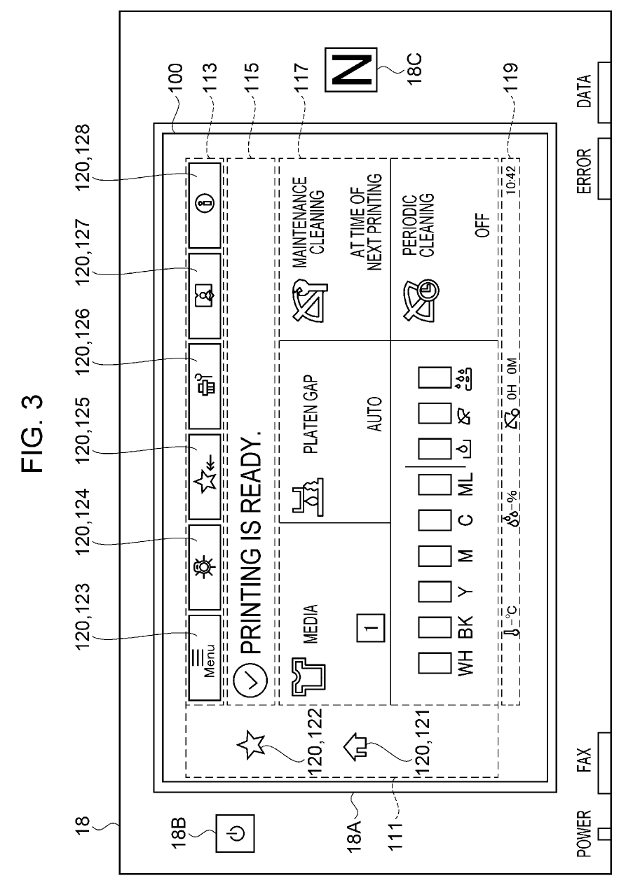

FIG. 3 shows a schematic configuration of the control panel 18. FIG. 3 shows an example of the home screen 100 displayed on the display panel 18A included in the control panel 18. The home screen 100 is displayed on the display panel 18A under the control of the display controller 41. The control panel 18 includes a power button 18B and an NFC reader 18C. NFC is an abbreviation for “Near Field Communication”.

The power button 18B receives an inputting operation performed by a user. When a user performs an inputting operation on the power button 18B, the power of the printer 10 is turned on or off. The power button 18B shown in FIG. 3 is provided inside the control panel 18. However, the power button 18B may be provided at a position different from the control panel 18.

The NFC reader 18C reads an NFC tag embedded in a personal identification card for identification of a user. The NFC reader 18C has a reading function of reading an NFC tag. The NFC reader 18C can read an NFC tag and acquire user identification information for identification of a user.

The display panel 18A displays the home screen 100 under the control of the display controller 41. The display panel 18A includes a first icon displaying area 111, a second icon displaying area 113, a state displaying area 115, an information displaying area 117, and an environment information displaying area 119. The display panel 18A displays various icons 120 and various information in the first icon displaying area 111 and the like.

The first icon displaying area 111 is a region in which one or more icons 120 are displayed. The first icon displaying area 111 is displayed when a screen other than the home screen 100 is displayed. The icons 120 disposed in the first icon displaying area 111 are always displayed. The first icon displaying area 111 shown in FIG. 3 is composed of one area. However, the present disclosure is not limited thereto. The first icon displaying area 111 may be divided into a plurality of areas. The position of the first icon displaying area 111 can be appropriately set. A home icon 121 and the user setting icon 122 are displayed in the first icon displaying area 111 shown in FIG. 3. The icons 120 other than the home icon 121 and the user setting icon 122 may also be displayed in the first icon displaying area 111.

Each icon 120 receives an inputting operation performed by a user. When the icon 120 receives an inputting operation performed by a user, the control panel 18 generates input information and transmits the input information to the control unit 40. The input information includes at least one of displaying instruction data and operation instruction data. The displaying instruction data is data that causes the display panel 18A to display a display screen associated with the icon 120. The operation instruction data is data that causes the printing mechanism 20 to execute an operation associated with the icon 120.

An inputting operation is performed on the home icon 121 when a user wants to change a screen displayed on the display panel 18A to the home screen 100. The home icon 121 is an example of the icon 120. The home icon 121 is lighted up or grayed out. The home icon 121 receives an inputting operation performed by a user when the home icon 121 is lighted up. The home icon 121 does not receive an inputting operation performed by a user when the home icon 121 is grayed out. When a user performs an inputting operation on the home icon 121, the home screen 100 is displayed on the display panel 18A.

The user setting icon 122 is configured such that an inputting operation performed on the control panel 18 by a user can be registered for the user setting icon 122. The user setting icon 122 is an example of the icon 120. The user setting icon 122 corresponds to an example of a user setting key. Registration information is registered for the user setting icon 122 under the control of the panel function controller 47. The user setting icon 122 receives an inputting operation performed by a user. When a user performs an inputting operation on the user setting icon 122, the display controller 41 causes the control panel 18 to display at least a part of the inputting operation based on the registration information. Alternatively, when a user performs an inputting operation on the user setting icon 122, the printing controller 43 causes the printing mechanism 20 to execute an operation based on the registration information.

The second icon displaying area 113 is a region in which one or more icons 120 are displayed. The icons 120 displayed in the second icon displaying area 113 may or may not be displayed when a screen other than the home screen 100 is displayed. The second icon displaying area 113 shown in FIG. 3 is composed of one area. However, the present disclosure is not limited thereto. The second icon displaying area 113 may be divided into a plurality of areas. The position of the second icon displaying area 113 can be appropriately set. A setting menu icon 123, an internal light icon 124, a function selection icon 125, a maintenance icon 126, a manual link icon 127, and a warning notification icon 128 are displayed in the second icon displaying area 113.

An inputting operation is performed on the setting menu icon 123 when a user wants to cause the display panel 18A to display a setting menu. The setting menu icon 123 is an example of the icon 120. The setting menu is a screen in which a list of various settings related to the printing mechanism 20 is displayed. Various settings related to the printing mechanism 20 include gap adjustment or the like between the medium supporting member and the printing head 21. When a user performs an inputting operation on the setting menu icon 123, the display controller 41 causes the display panel 18A to display the setting menu.

An inputting operation is performed on the internal light icon 124 when a user wants to turn on or off an internal light. The internal light icon 124 is an example of the icon 120. The internal light (not shown) is provided in the housing 12 of the printer 10. When a user performs an inputting operation on the internal light icon 124, the internal light is turned on or off. When the internal light is turned on, the user can easily visually recognize the inside of the housing 12 through the window portion 17. The user can check the state of a medium that is transported inside the housing 12 by the medium transporter 23.

An inputting operation is performed on the function selection icon 125 when a user wants to cause the display panel 18A to display a registration function menu screen 105. The function selection icon 125 is an example of the icon 120. When a user performs an inputting operation on the function selection icon 125, the display controller 41 causes the display panel 18A to display the registration function menu screen 105. In the registration function menu screen 105, registration information names corresponding to registration information, which will be described later, are displayed in the form of a list. The registration function menu screen 105 corresponds to an example of a selection list. Details of the registration function menu screen 105 will be described later.

An inputting operation is performed on the maintenance icon 126 when a user wants to cause the display panel 18A to display a maintenance menu list. The maintenance icon 126 is an example of the icon 120. When a user performs an inputting operation on the maintenance icon 126, the display controller 41 causes the display panel 18A to display the maintenance menu list (not shown). The maintenance menu list includes one or more maintenance items related to a maintenance operation such as the cleaning of a component and replacement of consumables. When a user selects a maintenance item included in the maintenance menu list, the user can execute a maintenance operation related to the selected item.

An inputting operation is performed on the manual link icon 127 when a user wants to access an online manual. The manual link icon 127 is an example of the icon 120. When a user performs an inputting operation on the manual link icon 127, the display controller 41 causes the display panel 18A to display a two-dimensional code. The two-dimensional code includes address information with which it is possible to directly access the online manual. When the user causes a smartphone or the like to read the two-dimensional code, the online manual is displayed on the smartphone. The user can check the online manual.

An inputting operation is performed on the warning notification icon 128 when a user wants to cause the display panel 18A to display warning notification. The display controller 41 adds a predetermined mark to the warning notification icon 128 when the printing controller 43 generates warning notification. When a user performs an inputting operation on the warning notification icon 128 to which the predetermined mark is added, the display controller 41 causes the display panel 18A to display a warning list screen including one or more warning notification names. When the user performs an inputting operation on a warning notification name included in the warning list screen, the display controller 41 causes the display panel 18A to display warning notification corresponding to the warning notification name. The user can check the warning notification.

The state displaying area 115 is an area in which notification about the state of the printer 10, notification about a warning, or the like is displayed. In the state displaying area 115, for example, information indicating that the printer 10 is in an idling state, information indicating that the printer 10 is in a printing job waiting state, or the like is displayed. The latest warning notification may be displayed in the state displaying area 115. A user can check the state of the printer 10 by visually recognizing the state displaying area 115.

In the information displaying area 117, various information related to the printer 10 is displayed. In the information displaying area 117, media information, consumable information, and the like are displayed. Information to be displayed in the information displaying area 117 is set in advance.

In the environment information displaying area 119, environment information on an environment in which the printer 10 is installed is displayed. The environment information includes a temperature, humidity, a time, and the like. The temperature and humidity are measured by a temperature and humidity sensor (not shown). As the time, a time measured by a timer is displayed (not shown).

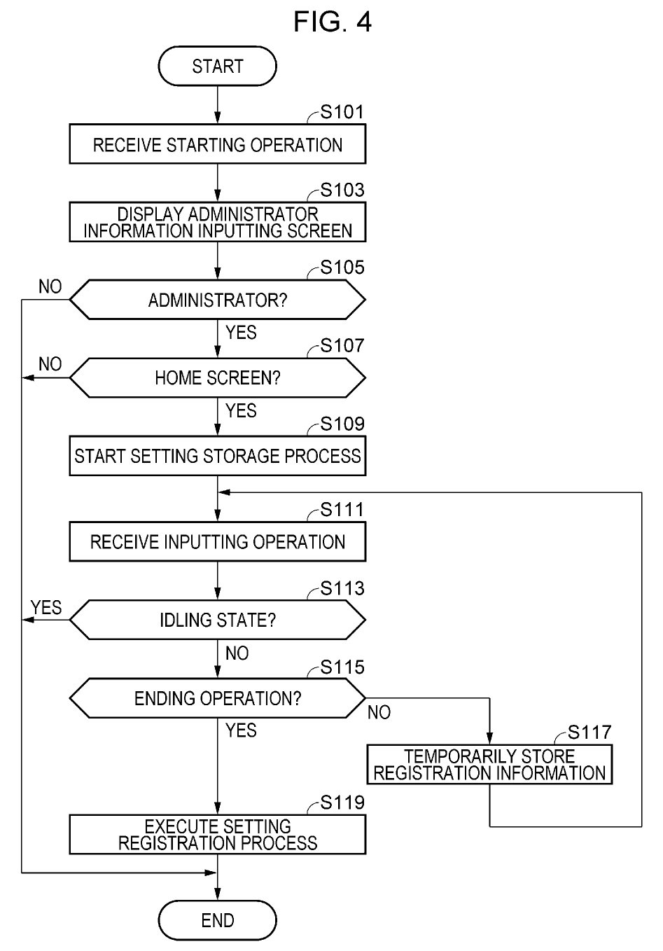

FIG. 4 shows an example of the control flow executed by the printer 10. FIG. 4 shows control flow executed when the panel function controller 47 of the control unit 40 performs the setting storage process and a setting registration process. FIG. 4 shows the control flow in the form of a flowchart. The control flow corresponds to an example of a control method. FIG. 4 shows control flow in which user identification information is received before the panel function controller 47 executes the setting storage process.

In step S101, the printer 10 receives a starting operation. The control panel 18 receives the starting operation as an inputting operation performed by a user. The starting operation is an inputting operation of instructing the panel function controller 47 to start the setting storage process and to start the setting registration process. The setting storage process is a process of generating and storing registration information to be registered for the user setting icon 122. The setting registration process is a process of registering the registration information for the user setting icon 122. The starting operation corresponds to an example of a registration starting operation. The starting operation is, for example, an operation of pressing the user setting icon 122 for a long time. The starting operation is not limited to an operation of pressing the user setting icon 122 for a long time. The starting operation is appropriately set.

After the starting operation is received, the printer 10 displays an administrator information inputting screen 101 in step S103. The administrator information inputting screen 101 receives user identification information for identification of the user. The administrator information inputting screen 101 corresponds to an example of an identification information inputting screen. The user identification information includes, for example, a personal identification number and a password. The user identification information corresponds to an example of identification information. The display controller 41 of the control unit 40 causes the display panel 18A to display the administrator information inputting screen 101. The display panel 18A displays the administrator information inputting screen 101.

After the administrator information inputting screen 101 is displayed, the printer 10 determines whether or not the user is an administrator in step S105. An administrator is a user who has an authority to change a predetermined designated setting item which is one of a plurality of setting items for the printer 10. Administrator information is stored in advance in the storage unit 30 in association with a personal identification number and a password. For example, the control unit 40 determines whether or not the user is an administrator by using a personal identification number and a password input to the administrator information inputting screen 101. When the control unit 40 determines that the user is the administrator, the printer 10 proceeds to step S107 (step S105: YES). When the control unit 40 determines that the user is not the administrator, the printer 10 ends the setting storage process and the setting registration process (step S105: NO). The printer 10 does not allow a user who is not an administrator to register the user setting icon 122.

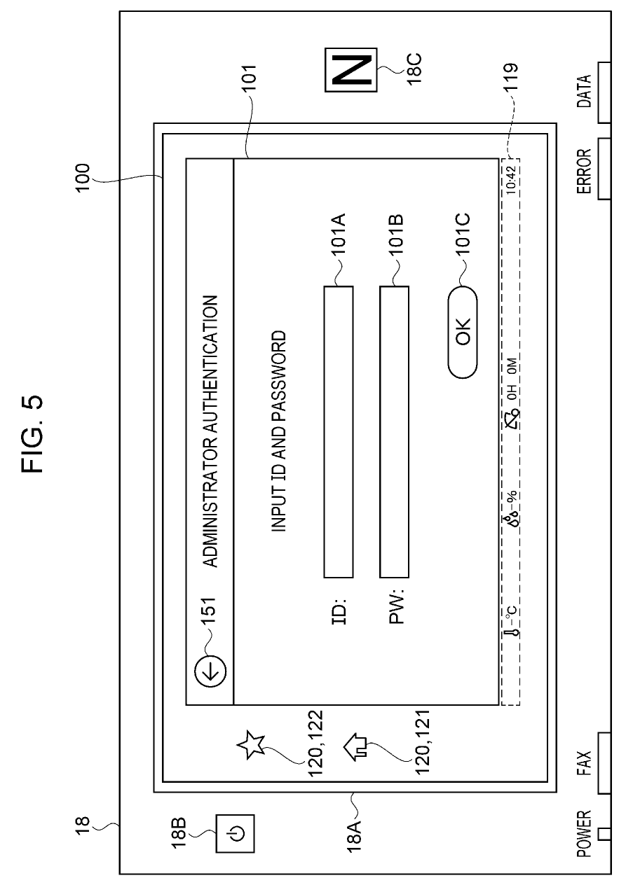

FIG. 5 shows a schematic configuration of the control panel 18. FIG. 5 shows an example of the administrator information inputting screen 101 displayed on the display panel 18A. FIG. 5 shows the display panel 18A on which the administrator information inputting screen 101 is displayed on the home screen 100. The administrator information inputting screen 101 may not be displayed in a state of being superimposed on the home screen 100. The way in which the administrator information inputting screen 101 is displayed is appropriately set. The administrator information inputting screen 101 includes an ID inputting field 101A, a password inputting field 101B, a confirmation button 101C, and a return button 151.

The ID inputting field 101A receives a personal identification number input by the user and the personal identification number is displayed in the ID inputting field 101A. The user inputs the personal identification number in the ID inputting field 101A. The user inputs the personal identification number by using an inputting button or a software keyboard (not shown) displayed on the display panel 18A.

The password inputting field 101B receives a password input by the user. The password may or may not be displayed in the password inputting field 101B. The user inputs the password by using an inputting button or a software keyboard.

The confirmation button 101C receives an inputting operation performed by the user. When the user performs an inputting operation on the confirmation button 101C, the control panel 18 transmits, to the control unit 40, a personal identification number and a password that are input to the control panel 18. The control unit 40 determines whether or not the user is an administrator by using the transmitted personal identification number and password.

The return button 151 receives an inputting operation performed by the user. When the user performs an inputting operation on the return button 151, the control panel 18 hides the administrator information inputting screen 101. The user stops inputting a personal identification number and a password. The printer 10 ends the setting storage process and the setting registration process.

FIG. 5 shows the administrator information inputting screen 101 on which a personal identification number and a password are input by means of a software keyboard or the like. However, the present disclosure is not limited thereto. The administrator information inputting screen 101 may include a reading instruction that causes the NFC reader 18C to read an NFC tag embedded in a personal identification card for identification of the user. The NFC tag includes a personal identification number and a password. When the user causes the NFC reader 18C to read the NFC tag based on the reading instruction, the personal identification number and the password are transmitted to the control unit 40. The control unit 40 determines whether or not the user is an administrator by using the personal identification number and the password transmitted from the NFC reader 18C.

As shown in FIG. 4, in step S107, the printer 10 determines whether or not the home screen 100 is being displayed on the display panel 18A. The user setting icon 122 is displayed in the first icon displaying area 111. The user can perform an inputting operation on the user setting icon 122 when a screen other than the home screen 100 is being displayed on the display panel 18A. The control panel 18 does not receive an inputting operation performed on the user setting icon 122 when a screen other than the home screen 100 is being displayed on the display panel 18A. When the control panel 18 determines that the home screen 100 is being displayed on the display panel 18A, the printer 10 proceeds to step S109 (step S107: YES). When the control panel 18 determines that the home screen 100 is not being displayed on the display panel 18A, the printer 10 ends the setting storage process and the setting registration process (step S107: NO). The printer 10 may cause the display panel 18A to display a message with an instruction to return to the home screen 100 when the control panel 18 determines that the home screen 100 is not being displayed on the display panel 18A.

The printer 10 starts the setting storage process in step S109. The panel function controller 47 sequentially stores, as the registration information, an inputting operation that is performed by the user on the control panel 18 after the starting operation and a display screen displayed due to the inputting operation. The registration information includes one or more inputting operations and one or more display screens. When the user performs an inputting operation on the control panel 18, the display panel 18A displays a display screen in accordance with the inputting operation. When the setting storage process is executed, the panel function controller 47 stores, as the registration information, setting information set at the control panel 18. When the setting storage process is executed, the printing mechanism 20 does not execute various operations such as a setting operation based on an inputting operation and a maintenance operation. The setting operation is an operation of changing the position of a member based on the setting information.

When the setting storage process is started, in step S111, the printer 10 receives an inputting operation performed by the user. The control panel 18 receives inputting operations performed on the various icons 120 displayed on the home screen 100 or the like. The panel function controller 47 acquires an inputting operation performed on the icon 120 as input information. The input information includes at least one of displaying instruction data and operation instruction data. The panel function controller 47 generates registration information including at least one of the displaying instruction data and the operation instruction data. When the input information includes the displaying instruction data, the panel function controller 47 acquires screen data of a display screen to be displayed in accordance with the inputting operation performed on the icon 120. The panel function controller 47 generates registration information including the screen data.

When the printer 10 receives the inputting operation, in step S113, the printer 10 determines whether or not the printing mechanism 20 is in an idling state. When the printer 10 receives a printing job transmitted from the printing control device 70 during the setting storage process, the printer 10 causes the printing mechanism 20 to transition into an idling state. When the printing mechanism 20 transitions into the idling state, the setting storage process is forcibly stopped. The panel function controller 47 stops the setting storage process before the setting storage process is forcibly stopped due to a printing operation of the printing mechanism 20. Since the panel function controller 47 stops the setting storage process when it is determined that the printing mechanism 20 is in the idling state, the setting storage process can be prevented from being stopped at an unexpected time. When the panel function controller 47 determines that the printing mechanism 20 is in the idling state, the printer 10 ends the setting storage process (step S113: YES). The printer 10 does not execute the setting registration process. When the panel function controller 47 determines that the printing mechanism 20 is not in the idling state, the printer 10 proceeds to step S115 (step S113: NO).

In step S115, the printer 10 determines whether or not an inputting operation is an ending operation. The control panel 18 determines whether or not an ending operation is received as an inputting operation performed by the user. The ending operation is an inputting operation of instructing the panel function controller 47 to end the setting storage process and to end the setting registration process. The ending operation corresponds to an example of a registration ending operation. The ending operation is, for example, an operation of pressing the user setting icon 122 for a long time. The ending operation is not limited to an operation of pressing the user setting icon 122 for a long time. The ending operation is appropriately set. When the panel function controller 47 determines that the inputting operation is not the ending operation, the printer 10 proceeds to step S117 (step S115: NO). When the panel function controller 47 determines that the inputting operation is the ending operation, the printer 10 proceeds to step S119 (step S115: YES).

The printer 10 temporarily stores the registration information in step S117. The panel function controller 47 temporarily stores, in the storage unit 30, the input information corresponding to the inputting operation performed on the icon 120. When the input information includes the displaying instruction data, the panel function controller 47 temporarily stores the screen data of the display screen to be displayed in accordance with the inputting operation, with the screen data being included in the registration information. After the registration information is temporarily stored, the printer 10 returns to step S111. The registration information temporarily stored is deleted from the storage unit 30 when the panel function controller 47 determines in step S113 that the printing mechanism 20 is in the idling state.

The printer 10 executes the setting registration process in step S119. The panel function controller 47 stores, in a predetermined storage region in the storage unit 30, the registration information including at least one of the input information and the screen data and ends the setting storage process. The panel function controller 47 executes the setting registration process of registering the registration information for the user setting icon 122. The printer 10 ends the process after the setting storage process and the setting registration process are executed.

The predetermined storage region may be configured such that one or more pieces of registration information can be stored. When a plurality of pieces of registration information can be registered in the predetermined storage region, the user performs the setting registration process by using the registration function menu screen 105. The panel function controller 47 causes the registration function menu screen 105 to be displayed after the setting storage process is ended, for example. The user refers to the registration function menu screen 105 to select registration information. The panel function controller 47 registers the selected registration information for the user setting icon 122. The setting registration process may be executed in accordance with control flow different from the setting storage process. When control flow for execution of the setting storage process and control flow for execution of the setting registration process are different from each other, the process in the control flow shown in FIG. 4 is ended in a state where the setting registration process is not executed. Control flow for execution of the setting registration process will be described later.

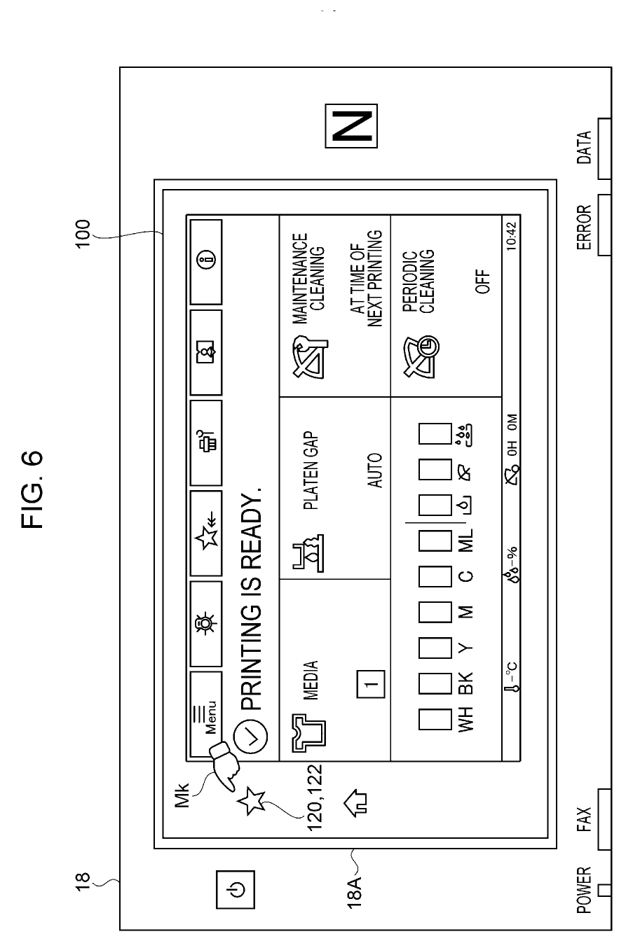

FIGS. 6, 7, 8, 9, 10, and FIG. 11 show a schematic configuration of the control panel 18. FIGS. 6, 7, 8, 9, 10, and FIG. 11 show examples of display screens displayed in the case of the control flow shown in FIG. 4. FIGS. 6, 7, 8, 9, 10, and FIG. 11 virtually show, with a mark image Mk, on which icon 120 an inputting operation is performed by the user. The mark image Mk is not displayed on the control panel 18.

FIG. 6 shows the home screen 100 displayed on the display panel 18A. When the user performs a predetermined inputting operation on the home screen 100 in step S101 of FIG. 4, the setting storage process and the setting registration process are started. For example, the user performs a predetermined inputting operation on the user setting icon 122 as shown in FIG. 6. The user performs a starting operation of pressing the user setting icon 122 for a long time. The control panel 18 receives the starting operation when the home screen 100 is being displayed on the display panel 18A.

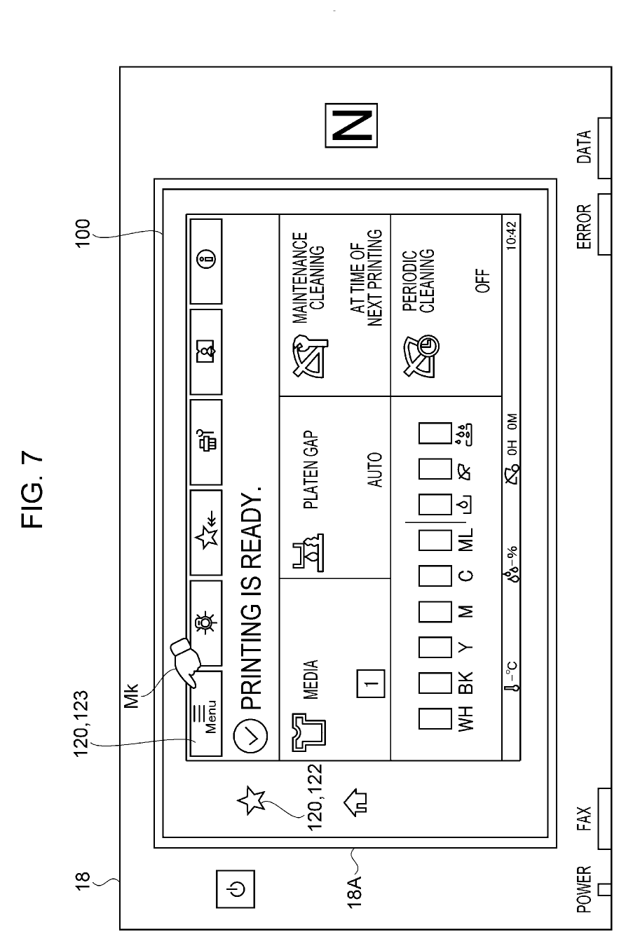

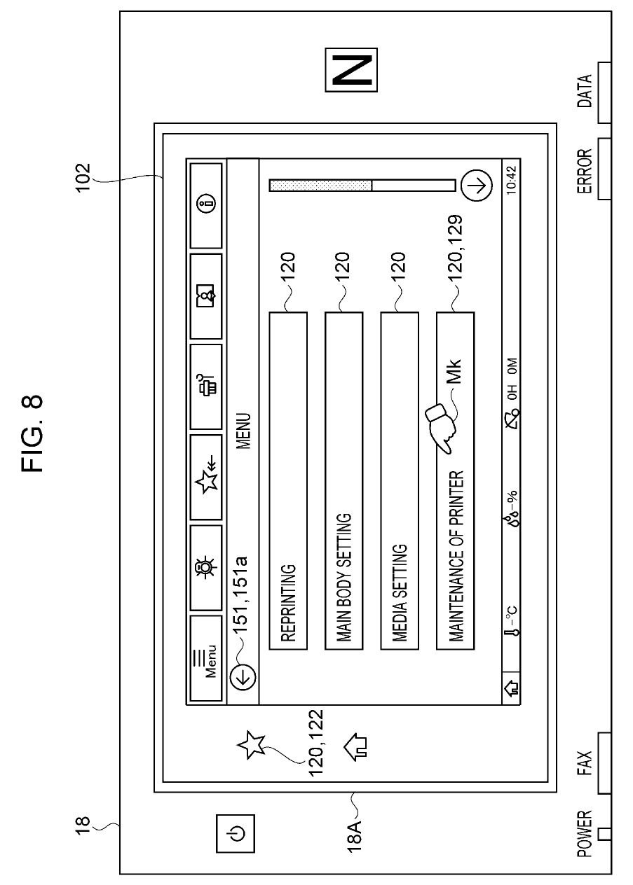

FIG. 7 shows the home screen 100 displayed on the display panel 18A. After the starting operation is performed, the user performs an inputting operation in step S111 of FIG. 4. The user performs the inputting operation on the setting menu icon 123 as shown in FIG. 7, for example. The control panel 18 generates setting menu input information indicating that the inputting operation on the setting menu icon 123 is performed by the user. The setting menu icon 123 has a function of causing a setting menu displaying screen 102 shown in FIG. 8 to be displayed when the inputting operation is executed. The control panel 18 generates setting menu displaying instruction data for the displaying of the setting menu displaying screen 102. The control panel 18 generates the setting menu input information including the setting menu displaying instruction data. The control panel 18 transmits the setting menu input information to the control unit 40. The panel function controller 47 of the control unit 40 acquires the setting menu input information and performs a process of temporarily storing the setting menu input information.

FIG. 8 shows the setting menu displaying screen 102 displayed on the display panel 18A. When the user performs the inputting operation on the setting menu icon 123, the control panel 18 causes the display panel 18A to display the setting menu displaying screen 102. In the setting menu displaying screen 102, the plurality of icons 120 including a printer maintenance icon 129 are displayed. In FIG. 8, the printer maintenance icon 129 is shown as “maintenance of printer”.

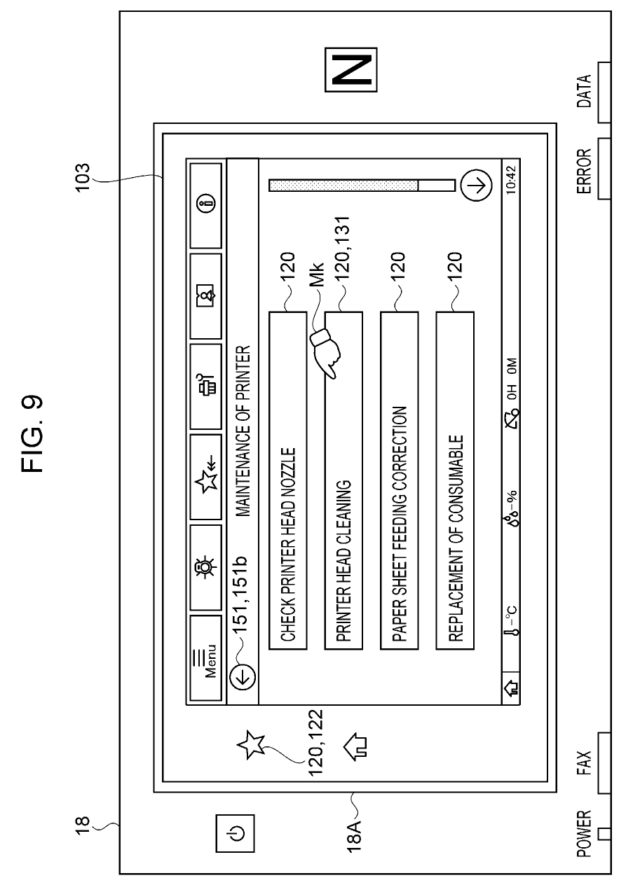

The user performs an inputting operation on the printer maintenance icon 129 as shown in FIG. 8, for example. The control panel 18 generates printer maintenance input information indicating that the inputting operation is performed on the printer maintenance icon 129. The printer maintenance icon 129 has a function of causing a printer maintenance menu displaying screen 103 shown in FIG. 9 to be displayed when the inputting operation is executed. The control panel 18 generates maintenance menu displaying instruction data for the displaying of the printer maintenance menu displaying screen 103. The control panel 18 generates the printer maintenance input information including the maintenance menu displaying instruction data. The control panel 18 transmits the printer maintenance input information to the control unit 40. The panel function controller 47 acquires the printer maintenance input information and performs a process of temporarily storing the printer maintenance input information.

The setting menu displaying screen 102 includes a first return button 151a. The first return button 151a is an example of the return button 151. The return button 151 corresponds to an example of a return key. When the user performs a return button inputting operation on the first return button 151a, the control panel 18 receives the return button inputting operation. The return button inputting operation is an example of an inputting operation, and corresponds to an example of a return key instruction operation. When the control panel 18 receives the return button inputting operation performed on the first return button 151a, the control panel 18 causes the display panel 18A to display the home screen 100.

FIG. 9 shows the printer maintenance menu displaying screen 103 displayed on the display panel 18A. When the user performs an inputting operation on the printer maintenance icon 129, the control panel 18 causes the display panel 18A to display the printer maintenance menu displaying screen 103. In the printer maintenance menu displaying screen 103, the plurality of icons 120 including a head cleaning icon 131 are displayed. In FIG. 9, the head cleaning icon 131 is shown as “printer head cleaning”.

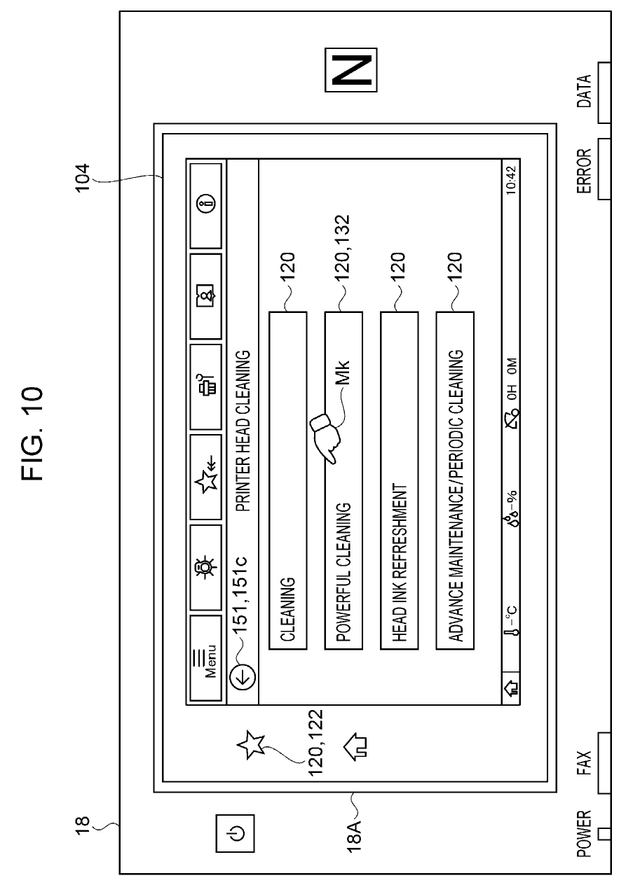

The user performs an inputting operation on the head cleaning icon 131 as shown in FIG. 9, for example. The control panel 18 generates head cleaning input information indicating that the inputting operation is performed on the head cleaning icon 131. The head cleaning icon 131 has a function of causing a head cleaning selection displaying screen 104 shown in FIG. 10 to be displayed when the inputting operation is executed. The control panel 18 generates maintenance menu displaying instruction data for the displaying of the head cleaning selection displaying screen 104. The control panel 18 generates the printer maintenance input information including the maintenance menu displaying instruction data. The control panel 18 transmits the printer maintenance input information to the control unit 40. The panel function controller 47 acquires the printer maintenance input information and performs a process of temporarily storing the printer maintenance input information.

The printer maintenance menu displaying screen 103 includes a second return button 151b. The second return button 151b is an example of the return button 151. When the user performs a return button inputting operation on the second return button 151b, the control panel 18 receives the return button inputting operation. When the control panel 18 receives the return button inputting operation performed on the second return button 151b, the control panel 18 causes the display panel 18A to display the setting menu displaying screen 102.

FIG. 10 shows the head cleaning selection displaying screen 104 displayed on the display panel 18A. When the user performs an inputting operation on the head cleaning icon 131, the control panel 18 causes the display panel 18A to display the head cleaning selection displaying screen 104. In the head cleaning selection displaying screen 104, the plurality of icons 120 including a powerful cleaning icon 132 are displayed.

The user performs an inputting operation on the powerful cleaning icon 132 as shown in FIG. 10, for example. The control panel 18 generates powerful cleaning input information indicating that the inputting operation is performed on the powerful cleaning icon 132. The powerful cleaning icon 132 has a function of causing the printing mechanism 20 to execute a predetermined cleaning process when the inputting operation is executed. The control panel 18 generates powerful cleaning execution instruction data for execution of a predetermined cleaning process. The control panel 18 generates the powerful cleaning input information including the powerful cleaning execution instruction data. The control panel 18 transmits the powerful cleaning input information to the control unit 40. The panel function controller 47 acquires the powerful cleaning input information and performs a process of temporarily storing the powerful cleaning input information.

The head cleaning selection displaying screen 104 includes a third return button 151c. The third return button 151c is an example of the return button 151. When the user performs a return button inputting operation on the third return button 151c, the control panel 18 receives the return button inputting operation. When the control panel 18 receives the return button inputting operation performed on the third return button 151c, the control panel 18 causes the display panel 18A to display the printer maintenance menu displaying screen 103.

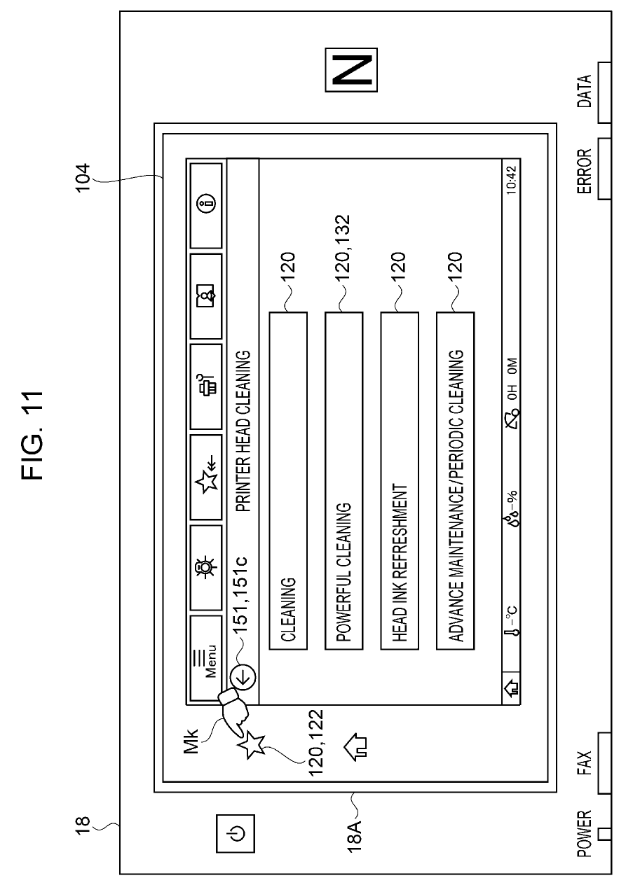

FIG. 11 shows the head cleaning selection displaying screen 104 displayed on the display panel 18A. When the user performs a predetermined inputting operation on the head cleaning selection displaying screen 104 in step S111 of FIG. 4, the setting registration process is executed. For example, the user performs the predetermined inputting operation on the user setting icon 122 as shown in FIG. 11. The user performs an ending operation of pressing the user setting icon 122 for a long time. The control panel 18 receives the ending operation.

The user performs the ending operation after performing the inputting operation on the powerful cleaning icon 132 as shown in FIG. 10, for example. The panel function controller 47 acquires the setting menu input information, the printer maintenance input information, and the powerful cleaning input information that are temporarily stored. The panel function controller 47 generates, as registration information, cleaning execution registration information including the setting menu input information, the printer maintenance input information, and the powerful cleaning input information. The cleaning execution registration information is an example of execution registration information. The cleaning execution registration information is information that causes the printing head 21 to execute powerful cleaning. The panel function controller 47 generates the cleaning execution registration information based on inputting operations performed on the control panel 18 after the starting operation. The panel function controller 47 generates the cleaning execution registration information based on inputting operations performed on the control panel 18 before the ending operation. The panel function controller 47 executes the setting storage process of storing the cleaning execution registration information. The panel function controller 47 executes the setting registration process of registering the cleaning execution registration information in a predetermined storage region of the storage unit 30. The panel function controller 47 performs the setting registration process of registering the cleaning execution registration information for the user setting icon 122 by registering the cleaning execution registration information in the predetermined storage region.

The user may perform the ending operation before performing the inputting operation on the powerful cleaning icon 132 as shown in FIG. 10. The panel function controller 47 acquires the setting menu input information and the printer maintenance input information that are temporarily stored. The panel function controller 47 generates, as registration information, cleaning display registration information including the setting menu input information and the printer maintenance input information. The cleaning display registration information is an example of the display registration information. The cleaning display registration information is information that causes the display panel 18A to display the head cleaning selection displaying screen 104. The panel function controller 47 executes the setting storage process of storing the cleaning display registration information. The panel function controller 47 executes the setting registration process of registering the cleaning display registration information in a predetermined storage region of the storage unit 30. The panel function controller 47 performs the setting registration process of registering the cleaning display registration information for the user setting icon 122 by registering the cleaning display registration information in the predetermined storage region.

The printer 10 includes the printing mechanism 20 that performs printing, the control panel 18 that displays the plurality of icons 120 and that receives inputting operations performed by a user, the control unit 40 that controls the control panel 18, and the communication unit 50 that communicates with the printing control device 70. The plurality of icons 120 include the user setting icon 122 for which an inputting operation performed on the control panel 18 by the user is registered. When the user performs an inputting operation on the control panel 18, the control unit 40 performs a setting storage process of storing registration information based on the inputting operation and a setting registration process of registering the registration information for the user setting icon 122.

It is easy for the user to search for a desired icon 120 since the user setting icon 122 is provided. Alternatively, it is easy for the user to cause the printing mechanism 20 to execute a desired operation such as head cleaning since the user setting icon 122 is provided.

The inputting operations include a starting operation performed on the user setting icon 122. It is preferable that the registration information is generated based on the inputting operation that is performed on the control panel 18 after the starting operation.

Since the starting operation is set in advance, it is easy for the user to perform the setting storage process and the setting registration process.

The inputting operations include an ending operation performed on the user setting icon 122. It is preferable that the registration information is generated based on the inputting operation that is performed on the control panel 18 before the ending operation.

Since the ending operation is set in advance, it is easy for the user to perform the setting storage process and the setting registration process.

It is preferable that the control panel 18 displays the administrator information inputting screen 101 for reception of the user identification information for identification of the user.

The printer 10 can determine whether or not the user is an administrator of the printer 10.

The control unit 40 receives the user identification information that is input on the administrator information inputting screen 101 by the user. It is preferable that the control unit 40 performs the setting storage process and the setting registration process after reception of the user identification information.

The printer 10 can cause a user, who is the administrator, to execute the setting storage process and the setting registration process.

The communication unit 50 receives a printing job that causes the printing mechanism 20 to execute printing. It is preferable that the control unit 40 causes the printing mechanism 20 to transition into an idling state and stops the setting storage process when the communication unit 50 receives the printing job during the setting storage process.

Since the printer 10 stops the setting storage process at the time of a transition into the idling state, the setting storage process can be prevented from being stopped at an unexpected time.

The communication unit 50 receives the registration information. It is preferable that the control unit 40 performs the setting registration process of registering, for the user setting icon 122, the registration information received by the communication unit 50.

The user can perform the setting registration process by using the printing control device 70.

Control flow is executed in the printer 10 including the printing mechanism 20 that performs printing and the control panel 18 that displays the plurality of icons 120 including the user setting icon 122 and that receives an inputting operation performed by a user. The printer 10 receives the inputting operation that is performed on the control panel 18 by the user, stores registration information based on the inputting operation, and registers the registration information for the user setting icon 122.

Since the registration information is registered for the user setting icon 122, it is easy for the user to search for a desired icon 120. Alternatively, it is easy for the user to cause the printing mechanism 20 to execute a desired operation such as head cleaning.

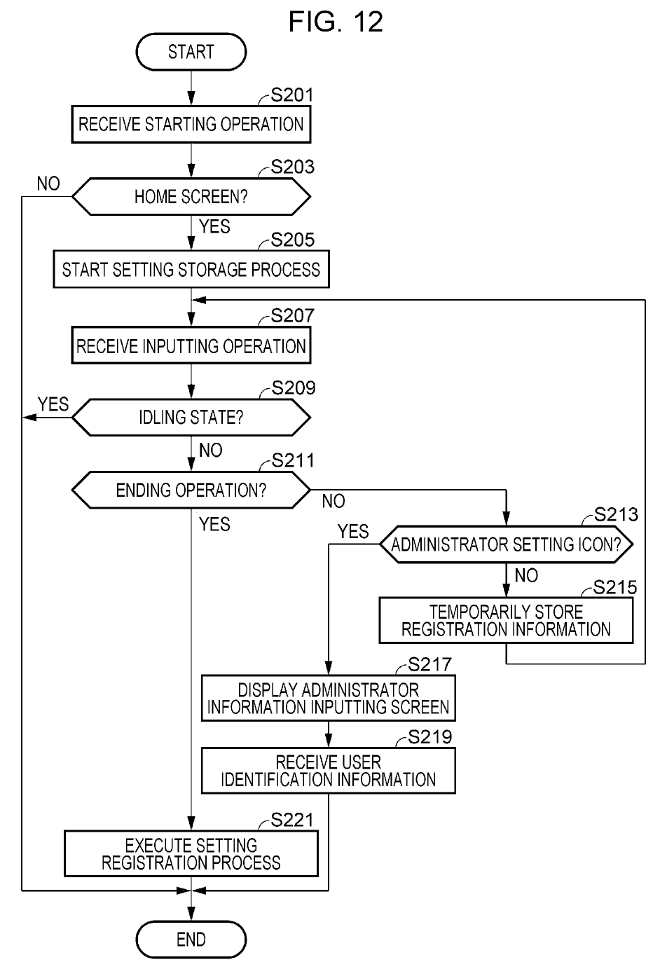

FIG. 12 shows an example of control flow executed by the printer 10. FIG. 12 shows control flow executed when the panel function controller 47 performs the setting storage process and the setting registration process. FIG. 12 shows the control flow in the form of a flowchart. FIG. 12 shows control flow in which user identification information is received while the panel function controller 47 is executing the setting storage process. Since the printer 10 receives the user identification information while the setting storage process is being executed, a user who has no administrator authority can register some functions for the user setting icon 122.

In step S201, the printer 10 receives a starting operation. The control panel 18 receives the starting operation as an inputting operation performed by a user.

After the starting operation is received, in step S203, the printer 10 determines whether or not the home screen 100 is being displayed on the display panel 18A. The control panel 18 does not receive an inputting operation performed on the user setting icon 122 when a display screen other than the home screen 100 is being displayed on the display panel 18A, for example. When the control panel 18 determines that the home screen 100 is being displayed on the display panel 18A, the printer 10 proceeds to step S205(step S203: YES). When the control panel 18 determines that the home screen 100 is not being displayed on the display panel 18A, the printer 10 ends the setting storage process and the setting registration process (step S203: NO). The printer 10 may cause the display panel 18A to display a message with an instruction to return to the home screen 100 when the control panel 18 determines that the home screen 100 is not being displayed on the display panel 18A.

The printer 10 starts the setting storage process in step S205. The panel function controller 47 sequentially stores, as the registration information, an inputting operation that is performed by the user on the control panel 18 after the starting operation and a display screen displayed due to the inputting operation.

When the setting storage process is started, in step S207, the printer 10 receives an inputting operation performed by the user. The control panel 18 receives inputting operations performed on the various icons 120 displayed on the home screen 100 or the like. The panel function controller 47 acquires an inputting operation performed on the icon 120 as input information.

When the printer 10 receives the inputting operation, in step S209, the printer 10 determines whether or not the printing mechanism 20 is in an idling state. When the printer 10 receives a printing job transmitted from the printing control device 70 during the setting storage process, the printer 10 causes the printing mechanism 20 to transition into an idling state. When the panel function controller 47 determines that the printing mechanism 20 is in the idling state, the printer 10 ends the setting storage process (step S209: YES). The printer 10 does not execute the setting registration process. When the panel function controller 47 determines that the printing mechanism 20 is not in the idling state, the printer 10 proceeds to step S211 (step S209: NO).

In step S211, the printer 10 determines whether or not an inputting operation is an ending operation. The control panel 18 determines whether or not an ending operation is received as an inputting operation performed by the user. When the panel function controller 47 determines that the inputting operation is not the ending operation, the printer 10 proceeds to step S213 (step S211: NO). When the panel function controller 47 determines that the inputting operation is the ending operation, the printer 10 proceeds to step S221 (step S211: YES).

In step S213, the printer 10 determines whether or not the icon 120 on which the inputting operation is performed is an administrator setting icon. The icons 120 include an administrator setting icon and a user setting icon. The administrator setting icon is the icon 120 that is associated with a function that can be set by a user who has an administrator authority. The user setting icon is the icon 120 that is associated with a function that can be set by a user who has no administrator authority. The panel function controller 47 determines whether or not the icon 120 on which the inputting operation is performed is an administrator setting icon. When the panel function controller 47 determines that the icon 120 on which the inputting operation is performed is not the administrator setting icon, the printer 10 proceeds to step S215 (step S213: NO). When the panel function controller 47 determines that the icon 120 on which the inputting operation is performed is the administrator setting icon, the printer 10 proceeds to step S217 (step S213: YES).

The printer 10 temporarily stores the registration information in step S215. The panel function controller 47 temporarily stores, in the storage unit 30, the input information corresponding to the inputting operation performed on the icon 120. After the registration information is temporarily stored, the printer 10 returns to step S207.

The printer 10 displays the administrator information inputting screen 101 in step S217. The display controller 41 causes the display panel 18A to display the administrator information inputting screen 101. The display panel 18A displays the administrator information inputting screen 101.

After the administrator information inputting screen 101 is displayed, the printer 10 receives user identification information in step S219. When the panel function controller 47 receives the user identification information, the panel function controller 47 stops the setting storage process. The panel function controller 47 ends the setting storage process without storing the user identification information. The panel function controller 47 does not register, for the user setting icon 122, registration information including the user identification information. The security of the printer 10 is improved.

The printer 10 executes the setting registration process in step S221. The panel function controller 47 stores the registration information in a predetermined storage region of the storage unit 30 and ends the setting storage process. The panel function controller 47 registers the registration information for the user setting icon 122. The printer 10 ends the process after the setting storage process and the setting registration process are executed.

It is preferable that the control unit 40 stops the setting storage process and does not perform the setting registration process when the administrator information inputting screen 101 is displayed while the user is performing an inputting operation. The printer 10 does not register, for the user setting icon 122, the registration information including the user identification information. The security of the printer 10 is improved.

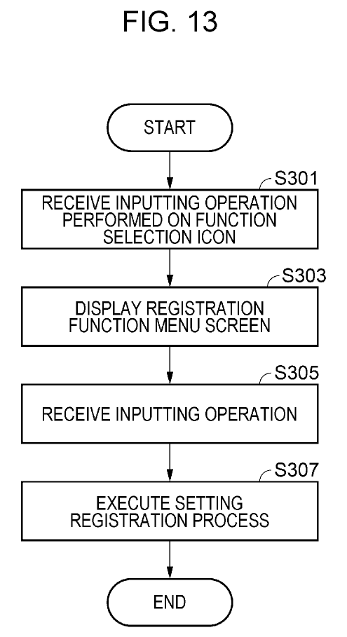

FIG. 13 shows an example of control flow executed by the printer 10. FIG. 13 shows control flow executed when the panel function controller 47 performs the setting registration process. FIG. 13 shows control flow executed when the setting registration process is performed at a different time from a time at which the setting storage process is performed. FIG. 13 shows control flow in which the registration function menu screen 105 is used.

In step S301, the printer 10 receives an inputting operation performed on the function selection icon 125. The user performs the inputting operation on the function selection icon 125 included in the home screen 100 shown in FIG. 3. When the user performs the inputting operation on the function selection icon 125, the control panel 18 receives the inputting operation.

After the inputting operation performed on the function selection icon 125 is received, the printer 10 displays the registration function menu screen 105 in step S303. The display controller 41 causes the display panel 18A to display the registration function menu screen 105. The display panel 18A displays the registration function menu screen 105.

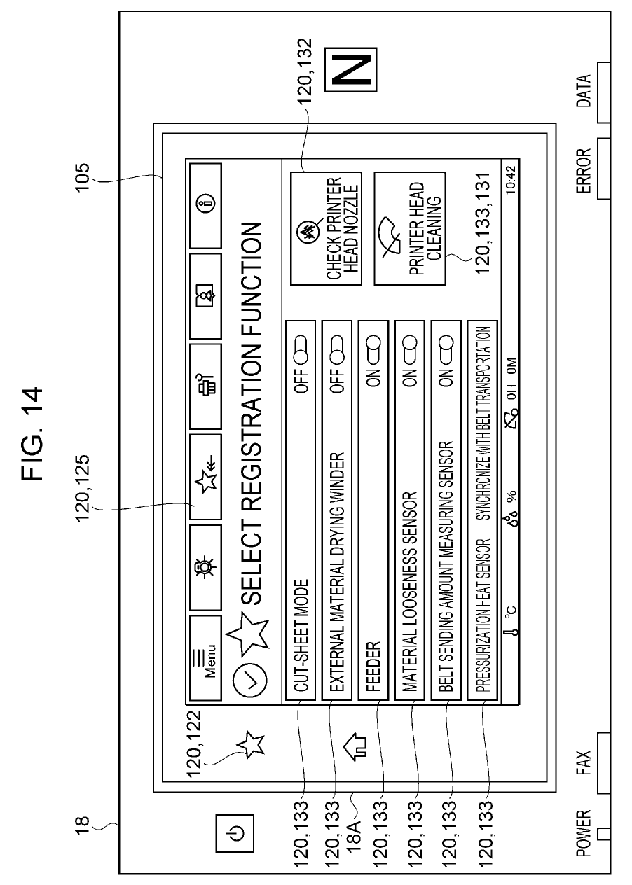

FIG. 14 shows a schematic configuration of the control panel 18. FIG. 14 shows an example of the registration function menu screen 105 displayed on the display panel 18A. The registration function menu screen 105 includes one or more setting storage icons 133.

The setting storage icon 133 is an example of the icon 120. The setting storage icon 133 is associated registration information stored in a predetermined storage region of the storage unit 30. The setting storage icon 133 corresponds to an example of a selection menu. The plurality of setting storage icons 133 include, for example, the head cleaning icon 131. The head cleaning icon 131 is associated with registration information that causes the display panel 18A to display the head cleaning selection displaying screen 104.

As shown in FIG. 13, after the registration function menu screen 105 is displayed, in step S305, the printer 10 receives an inputting operation. The control panel 18 receives an inputting operation performed on the setting storage icon 133.

When the inputting operation performed on the setting storage icon 133 is received, the printer 10 executes the setting registration process in step S307. The panel function controller 47 acquires registration information associated with the setting storage icon 133. The panel function controller 47 registers the registration information for the user setting icon 122. Since the registration function menu screen 105 is provided, the user can appropriately register the registration information for the user setting icon 122.

The control panel 18 displays the registration function menu screen 105 including the setting storage icon 133 associated with the registration information. It is preferable that the control unit 40 performs a setting registration process of registering the registration information associated with the setting storage icon 133 when the user selects the setting storage icon 133.

The user can appropriately register registration information for the user setting icon 122 by storing a plurality of pieces of registration information.

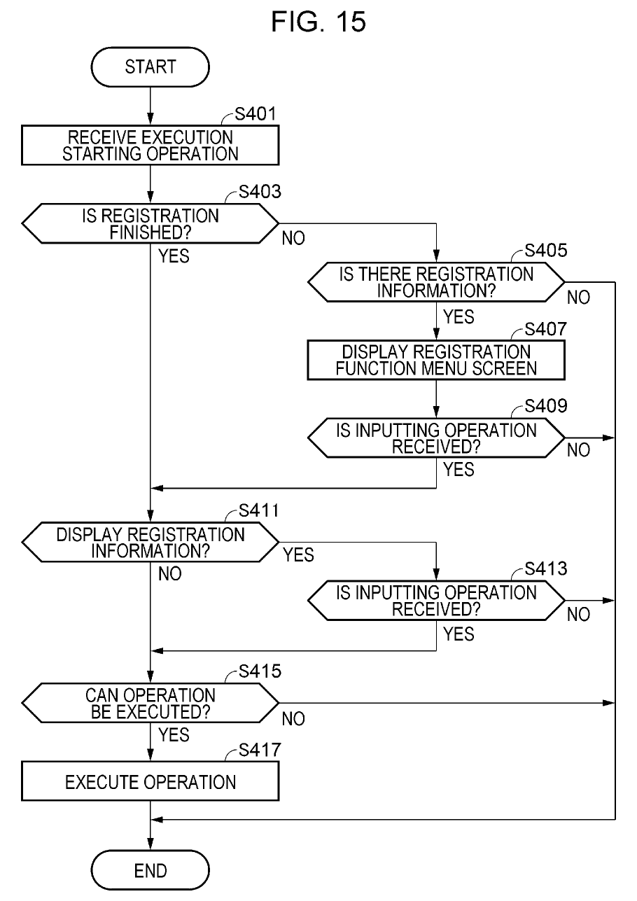

FIG. 15 shows an example of control flow executed by the printer 10. FIG. 15 shows control flow executed when a user performs an inputting operation on the user setting icon 122. FIG. 15 shows control flow in which the printer 10 is caused to operate based on registration information registered for the user setting icon 122.

In step S401, the printer 10 receives an execution starting operation. The printer 10 receives the execution starting operation as an inputting operation. The execution starting operation is an inputting operation for execution of an operation based on registration information registered for the user setting icon 122. The execution starting operation is, for example, an operation of pressing the user setting icon 122 for a short time. As the execution starting operation, an inputting operation different from a starting operation is set in advance.

When the execution starting operation is received, the printer 10 determines in step S403 whether or not there is registration information registered for the user setting icon 122. When the control unit 40 determines that there is registration information registered for the user setting icon 122, the printer 10 proceeds to step S411 (step S403: YES). When the control unit 40 determines that there is no registration information registered for the user setting icon 122, the printer 10 proceeds to step S405 (step S403: NO).

In step S405, the printer 10 determines whether or not there is registration information stored in the storage unit 30. The control unit 40 refers to a predetermined storage region of the storage unit 30 to determine whether or not there is registration information stored in the storage unit 30. When the control unit 40 determines that there is registration information stored in the storage unit 30, the printer 10 proceeds to step S407 (step S405: YES). When the control unit 40 determines that there is no registration information stored in the storage unit 30, the printer 10 ends the process (STEP S405: NO). When there is no registration information stored in the storage unit 30, the control unit 40 may cause the display panel 18A to display a message indicating that there is no registration information stored in the storage unit 30. After the message is displayed, the control unit 40 ends the process.

In step S407, the printer 10 causes the display panel 18A to display the registration function menu screen 105. The display panel 18A displays the registration function menu screen 105 shown in FIG. 14. The printer 10 displays the registration function menu screen 105 to prompt the user to register registration information for the user setting icon 122.

After the registration function menu screen 105 is displayed on the display panel 18A, in step S409, the printer 10 receives an inputting operation performed on the registration function menu screen 105. The control unit 40 receives an inputting operation performed on any of the plurality of icons 120 displayed in the registration function menu screen 105. When the user performs the inputting operation on the icon 120, the panel function controller 47 registers, for the user setting icon 122, registration information related to the icon 120. The printer 10 proceeds to step S411 (step S409: YES). When the user does not perform the inputting operation on the icon 120 within a time set in advance, the printer 10 ends the process (step S409: NO). The printer 10 may end the process after causing the display panel 18A to display a message indicating a timeout.

In step S411, the printer 10 determines whether or not the registration information registered for the user setting icon 122 is display registration information. When the control unit 40 determines that the registration information is the display registration information, a display screen is displayed on the display panel 18A based on the display registration information. The printer 10 proceeds to step S413 (step S411: YES). When the registration information is not the display registration information, the control unit 40 determines that the registration information is execution registration information. The printer 10 proceeds to step S415 (step S411: NO).

In step S413, the printer 10 receives an inputting operation performed on the display screen. The display screen displayed based on the display registration information includes one or more icons 120. The control panel 18 receives an inputting operation performed on the icon 120. When the user performs the inputting operation on the icon 120, the control panel 18 receives the inputting operation. The printer 10 acquires information regarding a function associated with the icon 120 and proceeds to step S415 (step S413: YES). When the user does not perform the inputting operation on the icon 120 within a time set in advance, the printer 10 ends the process (step S413: NO). The printer 10 may end the process after causing the display panel 18A to display a message indicating a timeout.

In step S415, the printer 10 determines whether or not the printing mechanism 20 can execute an operation. The control unit 40 determines whether or not the printing mechanism 20 can execute an operation based on the execution registration information. When the execution registration information is, for example, cleaning execution registration information, it is determined whether or not the printing mechanism 20 can execute powerful cleaning. The control unit 40 determines whether or not the printing mechanism 20 can execute a function associated with the icon 120 on the display screen on which the inputting operation is performed. When the control unit 40 determines that the printing mechanism 20 can execute the operation, the printer 10 proceeds to step S417 (step S415: YES). When the control unit 40 determines that the printing mechanism 20 cannot execute the operation, the printer 10 ends the process (step S415: NO).

In step S417, the printer 10 causes the printing mechanism 20 to execute the operation. The control unit 40 causes the printing mechanism 20 to execute the operation based on the execution registration information. Alternatively, the control unit 40 causes the printing mechanism 20 to execute the function associated with the icon 120 on the display screen on which the inputting operation is performed. The printer 10 executes an operation based on the registration information registered for the user setting icon 122 and ends the process.

When the registration information is, for example, cleaning display registration information, the control unit 40 causes the display panel 18A to display the head cleaning selection displaying screen 104 based on the cleaning display registration information when the user performs an execution starting operation on the user setting icon 122. The execution starting operation corresponds to an example of an instruction operation. The cleaning display registration information corresponds to an example of third screen display information. The display panel 18A displays the head cleaning selection displaying screen 104. The head cleaning selection displaying screen 104 corresponds to an example of a third screen.

The head cleaning selection displaying screen 104 is a display screen displayed on the display panel 18A when a head cleaning selection operation is received as an inputting operation performed on the head cleaning icon 131. The head cleaning icon 131 corresponds to an example of a second operation key. The head cleaning selection operation corresponds to an example of a second user instruction. The head cleaning icon 131 is included in the printer maintenance menu displaying screen 103. The printer maintenance menu displaying screen 103 corresponds to an example of a second screen.

The printer maintenance menu displaying screen 103 is a display screen displayed on the display panel 18A when a printer maintenance selection operation is received as an inputting operation performed on the printer maintenance icon 129. The printer maintenance icon 129 corresponds to an example of a first operation key. The printer maintenance selection operation corresponds to an example of a first user instruction. The printer maintenance icon 129 is one of the plurality of icons 120 displayed in the setting menu displaying screen 102. The setting menu displaying screen 102 corresponds to an example of a first screen.

The setting menu displaying screen 102 is a display screen displayed on the display panel 18A when an inputting operation performed on the setting menu icon 123 included in the home screen 100 is received.

The cleaning display registration information includes setting menu input information and printer maintenance input information. The setting menu input information includes an inputting operation that is performed on the setting menu icon 123 by the user. The printer maintenance input information includes a printer maintenance selection operation, maintenance menu displaying instruction data that causes the printer maintenance menu displaying screen 103 to be displayed, a head cleaning selection operation, and maintenance menu displaying instruction data that causes the head cleaning selection displaying screen 104 to be displayed.

The head cleaning selection displaying screen 104 includes the third return button 151c. The third return button 151c is an example of the return button 151. The head cleaning selection displaying screen 104 displayed based on the inputting operation performed on the user setting icon 122 receives a return button inputting operation as an inputting operation performed on the third return button 151c. When the control panel 18 receives the return button inputting operation performed on the third return button 151c included in the head cleaning selection displaying screen 104, the control panel 18 causes the display panel 18A to display the printer maintenance menu displaying screen 103. Since the printer maintenance menu displaying screen 103 is displayed, it is easy for a user to cause a display screen to be displayed, the display screen being related to registration information registered for the user setting icon 122.

The control panel 18 displays the setting menu displaying screen 102 in which the plurality of icons 120 including the printer maintenance icon 129 are displayed, the printer maintenance menu displaying screen 103 that includes the head cleaning icon 131 displayed when a printer maintenance selection operation performed on the printer maintenance icon 129 is received, and the head cleaning selection displaying screen 104 that includes the third return button 151c displayed when a head cleaning selection operation performed on the head cleaning icon 131 is received. The registration information is cleaning display registration information that includes inputting operations including the printer maintenance selection operation and the head cleaning selection operation and the displaying of the head cleaning selection displaying screen 104. The control unit 40 causes the control panel 18 to display the head cleaning selection displaying screen 104 when an execution starting operation performed on the user setting icon 122 for which the cleaning display registration information is registered is received. It is preferable that the control unit 40 causes the control panel 18 to display the printer maintenance menu displaying screen 103 when a return button inputting operation performed on the third return button 151c included in the head cleaning selection displaying screen 104 is received.

Since the printer maintenance menu displaying screen 103 is displayed, it is easy for a user to cause a display screen to be displayed, the display screen being related to registration information registered for the user setting icon 122.

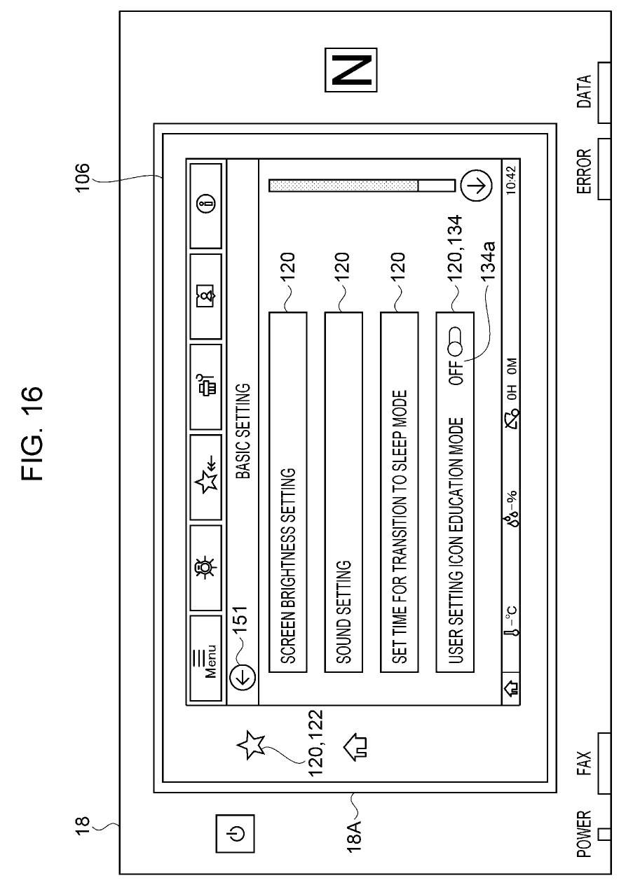

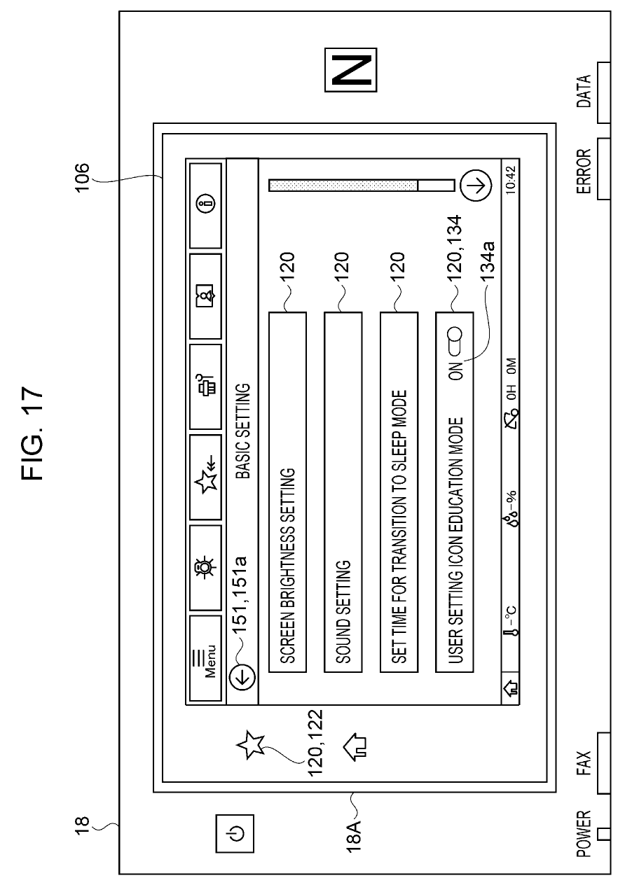

FIGS. 16 and 17 show a schematic configuration of the control panel 18. FIGS. 16 and 17 show an example of a basic setting screen 106 displayed on the display panel 18A. The basic setting screen 106 is displayed on the display panel 18A when an inputting operation is performed on a basic setting icon included in a main body setting screen (not shown). The main body setting screen is displayed on the display panel 18A when an inputting operation performed on the icon 120 related to main body setting is received, the icon 120 being included in the setting menu displaying screen 102.

In the basic setting screen 106, the plurality of icons 120 including an education mode setting icon 134 are displayed. The education mode setting icon 134 shown in FIGS. 16 and 17 is included in the basic setting screen 106. However, the present disclosure is not limited thereto. The disposition of the education mode setting icon 134 is appropriately set.

The education mode setting icon 134 receives an inputting operation performed by a user. When the user performs the inputting operation on the education mode setting icon 134, the operation mode controller 45 switches an operation mode to an education mode or a printing mode. The education mode setting icon 134 includes a mode setting switch 134a. The mode setting switch 134a is configured to be able to receive an inputting operation performed by a user.

When a user performs an inputting operation on the education mode setting icon 134 or the mode setting switch 134a, the operation mode is switched to the education mode or the printing mode. FIG. 16 shows the basic setting screen 106 displayed when the education mode is not set. When the operation mode is not the education mode and is the printing mode, the mode setting switch 134a is displayed in a manner indicating that the education mode is off. FIG. 17 shows the basic setting screen 106 displayed when the education mode is set. When the operation mode is the education mode, the mode setting switch 134a is displayed in a manner indicating that the education mode is on.

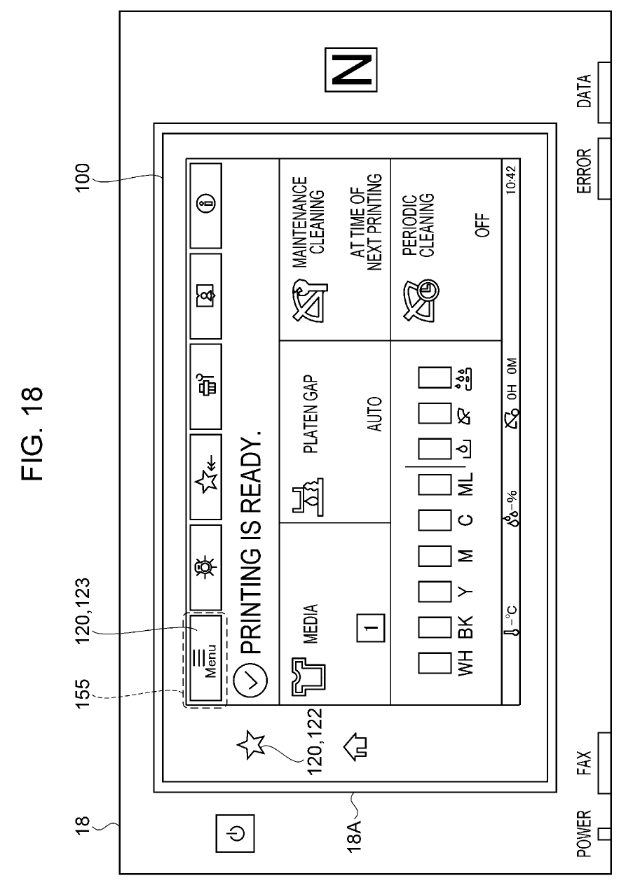

FIGS. 18, 19, 20, 21, 22, 23, and FIG. 24 show a schematic configuration of the control panel 18. FIGS. 18 to 24 show examples of display screens displayed when the education mode is set as the operation mode. FIGS. 18 to 24 show display examples of a case where head adjustment registration information, which is an example of registration information, is displayed on the display panel 18A. The head adjustment registration information is an example of execution registration information. The head adjustment registration information includes an execution instruction for execution of position adjustment of the printing head 21.

When the operation mode controller 45 switches the operation mode from the printing mode to the education mode, the printer 10 is set to enter the education mode. When a user performs, as an inputting operation, an information display starting operation on the control panel 18, the display panel 18A displays registration information.

FIG. 18 shows a display screen displayed when a user performs an information starting operation. The display panel 18A displays the home screen 100. The home screen 100 includes an icon instruction image 155.

The icon instruction image 155 shows the icon 120 on which the user performs an inputting operation when position adjustment of the printing head 21 is to be executed. The icon instruction image 155 is shown by a broken line in FIG. 18. However, the present disclosure is not limited thereto. The way in which the icon instruction image 155 is displayed is not limited as long as the user can identify on which icon 120 an inputting operation is performed.

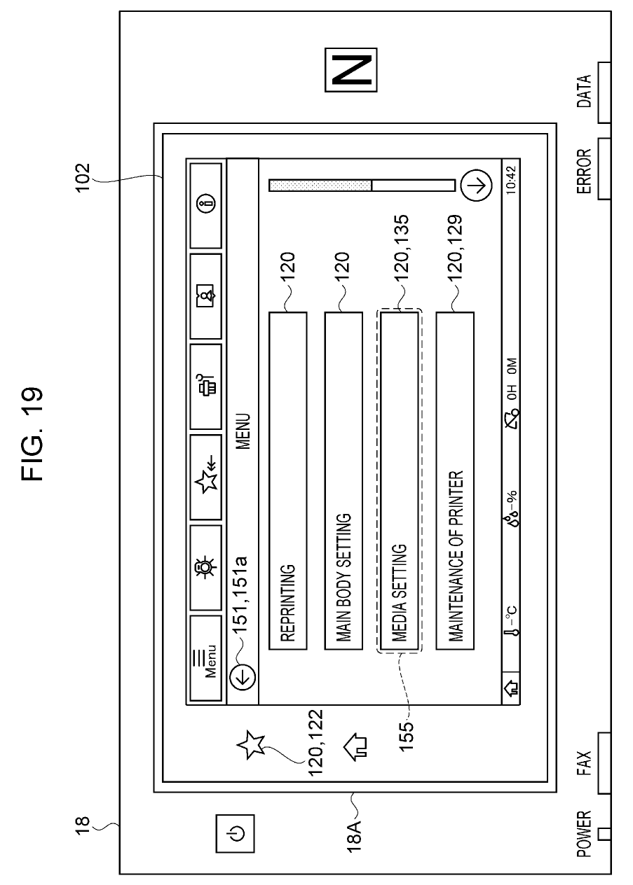

In FIG. 18, the icon instruction image 155 is displayed on the setting menu icon 123. The icon instruction image 155 indicates that the icon 120 on which the inputting operation is performed is the setting menu icon 123 by being displayed on the setting menu icon 123. When the inputting operation is performed on the setting menu icon 123, the setting menu displaying screen 102 shown in FIG. 19 is displayed. The setting menu displaying screen 102 shown in FIG. 19 may be displayed after the display panel 18A displays the home screen 100 including the icon instruction image 155 for a predetermined time.

FIG. 19 shows the setting menu displaying screen 102 that is displayed on the display panel 18A after the home screen 100 including the icon instruction image 155 is displayed. The setting menu displaying screen 102 includes the icon instruction image 155.

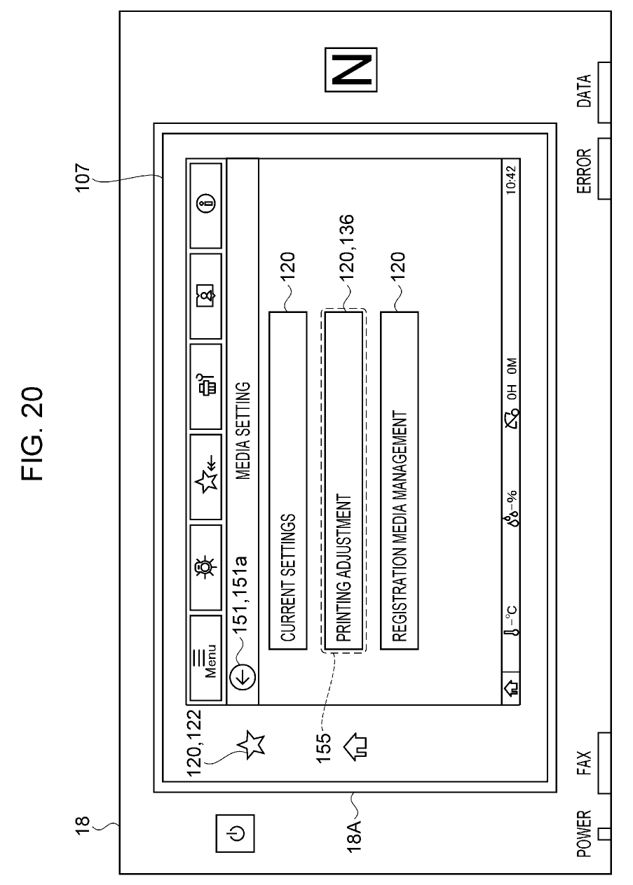

In FIG. 19, the icon instruction image 155 is displayed on a media setting icon 135. The icon instruction image 155 indicates that the icon 120 on which the inputting operation is performed is the media setting icon 135 by being displayed on the media setting icon 135. The media setting icon 135 is associated with a function of displaying a media setting selection screen 107 on the display panel 18A. When the inputting operation is performed on the media setting icon 135, the media setting selection screen 107 shown in FIG. 20 is displayed. The media setting selection screen 107 shown in FIG. 20 may be displayed after the display panel 18A displays the setting menu displaying screen 102 including the icon instruction image 155 for a predetermined time.

FIG. 20 shows the media setting selection screen 107 that is displayed on the display panel 18A after the setting menu displaying screen 102 including the icon instruction image 155 is displayed. The media setting selection screen 107 includes the icon instruction image 155.

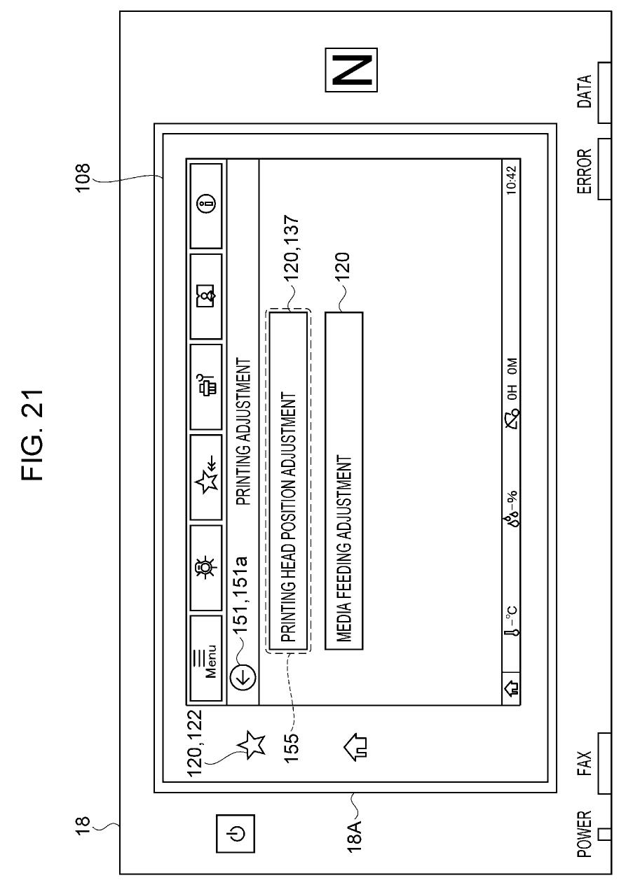

In FIG. 20, the icon instruction image 155 is displayed on a printing adjustment icon 136. The printing adjustment icon 136 is associated with a function of displaying a printing adjustment screen 108 on the display panel 18A. The icon instruction image 155 indicates that the icon 120 on which the inputting operation is performed is the printing adjustment icon 136 by being displayed on the printing adjustment icon 136. When the inputting operation is performed on the printing adjustment icon 136, the printing adjustment screen 108 shown in FIG. 21 is displayed. The printing adjustment screen 108 shown in FIG. 21 may be displayed after the display panel 18A displays the media setting selection screen 107 including the icon instruction image 155 for a predetermined time.

FIG. 21 shows the printing adjustment screen 108 that is displayed on the display panel 18A after the media setting selection screen 107 including the icon instruction image 155 is displayed. The printing adjustment screen 108 includes the icon instruction image 155.

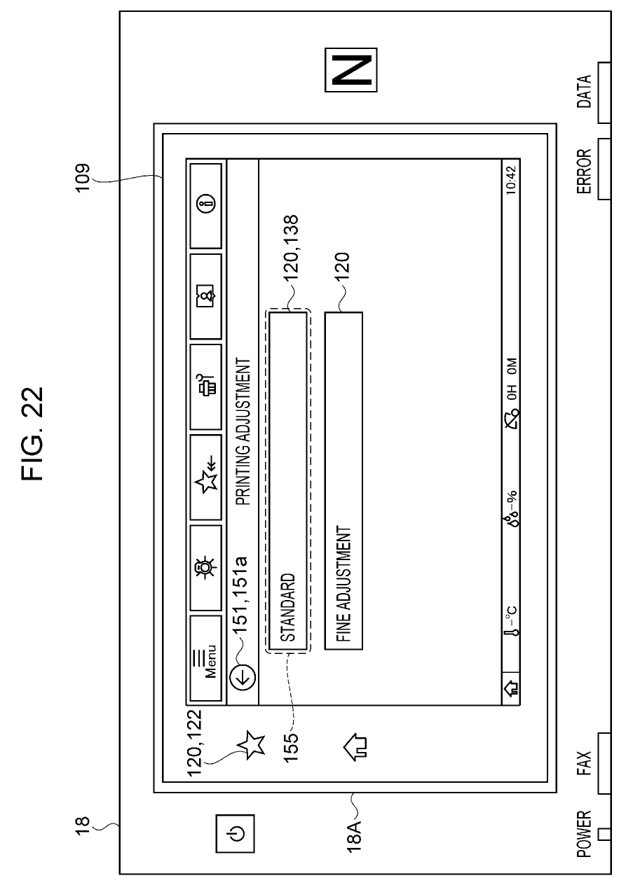

In FIG. 21, the icon instruction image 155 is displayed on a head position adjustment icon 137. The head position adjustment icon 137 is associated with a function of displaying a first head position adjustment screen 109 on the display panel 18A. The icon instruction image 155 indicates that the icon 120 on which the inputting operation is performed is the head position adjustment icon 137 by being displayed on the head position adjustment icon 137. When the inputting operation is performed on the head position adjustment icon 137, the first head position adjustment screen 109 shown in FIG. 22 is displayed. The first head position adjustment screen 109 shown in FIG. 22 may be displayed after the display panel 18A displays the printing adjustment screen 108 including the icon instruction image 155 for a predetermined time.

FIG. 22 shows the first head position adjustment screen 109 that is displayed on the display panel 18A after the printing adjustment screen 108 including the icon instruction image 155 is displayed. The first head position adjustment screen 109 includes the icon instruction image 155.

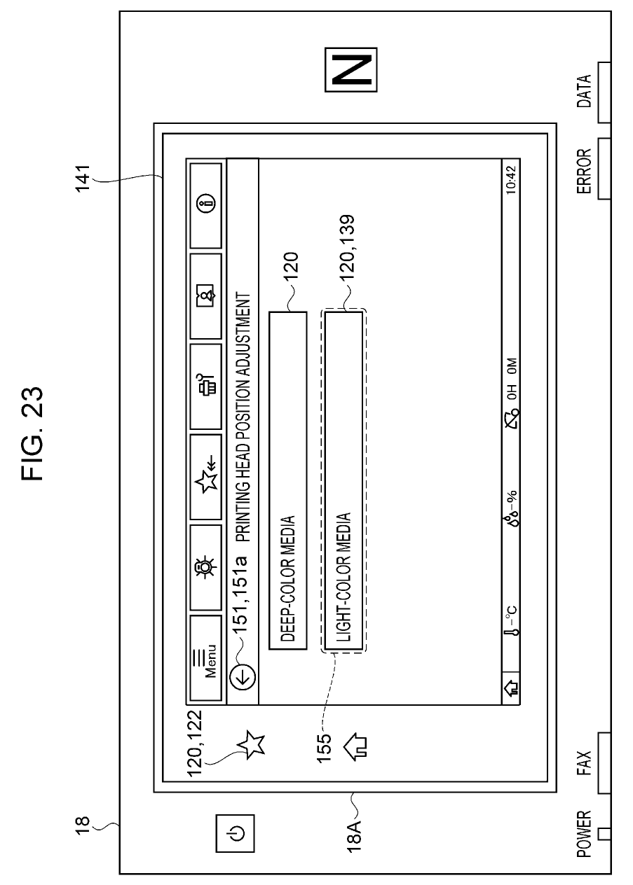

In FIG. 22, the icon instruction image 155 is displayed on a standard setting icon 138. The standard setting icon 138 is associated with a function of displaying a second head position adjustment screen 141 on the display panel 18A. The icon instruction image 155 indicates that the icon 120 on which the inputting operation is performed is the standard setting icon 138 by being displayed on the standard setting icon 138. When the inputting operation is performed on the standard setting icon 138, the second head position adjustment screen 141 shown in FIG. 23 is displayed. The second head position adjustment screen 141 shown in FIG. 23 may be displayed after the display panel 18A displays the first head position adjustment screen 109 including the icon instruction image 155 for a predetermined time.

FIG. 23 shows the second head position adjustment screen 141 that is displayed on the display panel 18A after the first head position adjustment screen 109 including the icon instruction image 155 is displayed. The second head position adjustment screen 141 includes the icon instruction image 155.

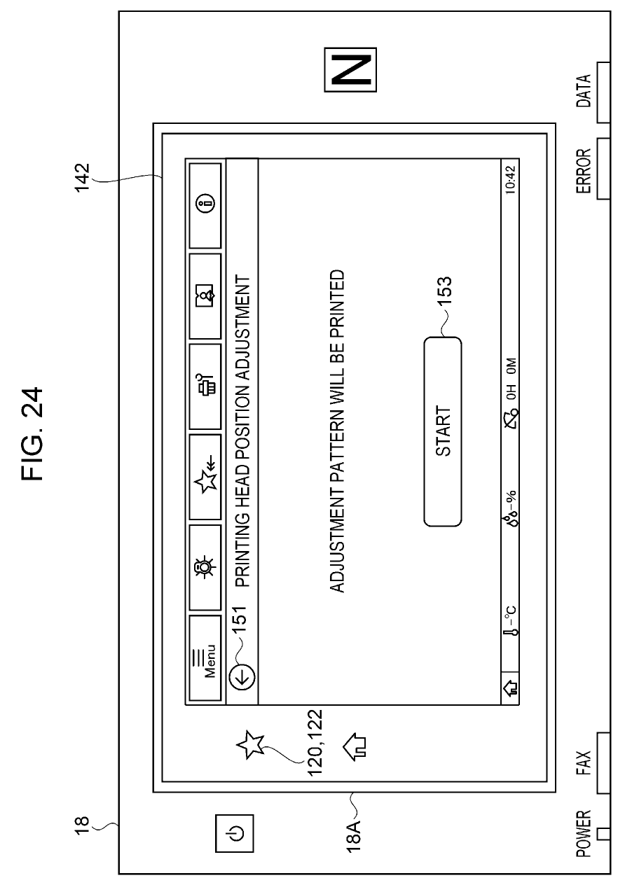

In FIG. 23, the icon instruction image 155 is displayed on a light-color media setting icon 139. The light-color media setting icon 139 is associated with a function of adjusting the position of the printing head 21 for a light-color media. The icon instruction image 155 indicates that the icon 120 on which the inputting operation is performed is the light-color media setting icon 139 by being displayed on the light-color media setting icon 139. When the inputting operation is performed on the light-color media setting icon 139, a head adjustment execution inputting screen 142 shown in FIG. 24 is displayed. The head adjustment execution inputting screen 142 shown in FIG. 24 may be displayed after the display panel 18A displays the second head position adjustment screen 141 including the icon instruction image 155 for a predetermined time.

FIG. 24 shows the head adjustment execution inputting screen 142 that is displayed on the display panel 18A after the second head position adjustment screen 141 including the icon instruction image 155 is displayed. The head adjustment execution inputting screen 142 is a display screen for confirmation of execution of head position adjustment of the printing head 21. The head adjustment execution inputting screen 142 includes the return button 151 and a start button 153. When an inputting operation is performed on the start button 153 at the time of the printing mode, an operation of head position adjustment of the printing head 21 is executed. The return button 151 changes what is displayed to the second head position adjustment screen 141.

In a displaying mode in which head adjustment registration information is displayed on the display panel 18A, the process is ended after the head adjustment execution inputting screen 142 shown in FIG. 24 is displayed. When a user performs a predetermined inputting operation, the printer 10 ends the displaying of various display screens in the education mode. The printer 10 may end the displaying of various display screens in the education mode after the head adjustment execution inputting screen 142 is displayed for a predetermined period of time. The user can check an operation procedure, a display screen, and the like related to registration information by checking the various display screens displayed in the education mode.

It is preferable that the control unit 40 causes the control panel 18 to operate in the education mode in which registration information registered in the setting registration process is displayed on the control panel 18.

The user can check an operation procedure, a display screen, and the like related to registration information by checking the various display screens displayed in the education mode.

What is claimed is:

1. A printing apparatus comprising:
a printing section that performs printing;
an operation panel that displays a plurality of operation keys and that receives an operation performed by a user;
a controller that controls the operation panel; and
a communication section that communicates with an external device, wherein
the plurality of operation keys include a user setting key for which the operation performed on the operation panel by the user is registered, and
when the user performs the operation on the operation panel, the controller performs a storage process of storing operation information based on the operation and a registration process of registering the operation information for the user setting key.

2. The printing apparatus according to claim 1, wherein
the operation panel displays a selection list including a selection menu associated with the operation information, and
the controller performs the registration process of registering the operation information associated with the selection menu when the user selects the selection menu.

3. The printing apparatus according to claim 1, wherein
the operation includes a registration starting operation performed on the user setting key, and
the operation information is generated based on the operation that is performed on the operation panel after the registration starting operation.

4. The printing apparatus according to claim 3, wherein
the operation includes a registration ending operation performed on the user setting key, and
the operation information is generated based on the operation that is performed on the operation panel before the registration ending operation.

5. The printing apparatus according to claim 1, wherein
the operation panel displays an identification information inputting screen for reception of identification information for identification of the user.

6. The printing apparatus according to claim 5, wherein
the controller receives the identification information that is input on the identification information inputting screen by the user, and
the storage process and the registration process are performed after the identification information is received.

7. The printing apparatus according to claim 5, wherein
the controller stops the storage process and does not perform the registration process when the identification information inputting screen is displayed while the user is performing the operation.

8. The printing apparatus according to claim 1, wherein
the communication section receives a printing instruction that causes the printing section to execute the printing, and
when the communication section receives the printing instruction during the storage process, the controller causes the printing section to transition into a printing-ready state and stops the storage process.

9. The printing apparatus according to claim 1, wherein
the controller causes the operation panel to operate in a displaying mode in which the operation information registered in the registration process is displayed on the operation panel.

10. The printing apparatus according to claim 1, wherein
the operation panel displays a first screen in which the plurality of operation keys including a first operation key are displayed, a second screen that includes a second operation key displayed when a first user instruction performed on the first operation key is received, and a third screen that includes a return key displayed when a second user instruction performed on the second operation key is received,
the operation information is third screen display information that includes the operation including the first user instruction and the second user instruction and displaying of the third screen, and
the controller causes the operation panel to display
the third screen when an instruction operation performed on the user setting key for which the third screen display information is registered is received, and
the second screen when a return key instruction operation performed on the return key included in the third screen is received.

11. The printing apparatus according to claim 1, wherein
the communication section receives the operation information, and
the controller performs the registration process of registering, for the user setting key, the operation information received by the communication section.

12. A control method for a printing apparatus including a printing section that performs printing and an operation panel that displays a plurality of operation keys including a user setting key and that receives an operation performed by a user, the method comprising:
receiving the operation that is performed on the operation panel by the user;
storing operation information based on the operation; and
registering the operation information for the user setting key.
